(19) United States
(12) Patent Application Publication
(10) Pub. No.: US 2026/0289198 A1
(43) Pub. Date: Sep. 24, 2026

(54) SYSTEM

(71) Applicant: SoftBank Group Corp., Tokyo (JP)

(72) Inventor: Fumitaka TANAKA, Tokyo (JP)

(73) Assignee: SoftBank Group Corp., Tokyo (JP)

(21) Appl. No.: 19/564,213

(22) Filed: Mar. 12, 2026

(30) Foreign Application Priority Data
Mar. 19, 2025 (JP) 2025-044549

(51) Int. Cl. G06F 40/58; G06F 40/103; G06F 40/205; G06F 40/295; G06N 3/0475

(52) U.S. Cl. CPC G06F 40/58; G06F 40/103; G06F 40/205; G06F 40/295; G06N 3/0475

(57) ABSTRACT

A system includes a processor that is configured to acquire information from an information source, convert the acquired information into text data and perform preprocessing on the text data, generate a prompt for instructing a generative AI model to summarize information based on the preprocessed text data and input the prompt into the generative AI model, format summarized information obtained from the generative AI model into a predetermined format and transmit the formatted summarized information to a terminal of a user, interactively adjust the summary of the information, and translate the summarized information into a different language.

### CROSS-REFERENCE TO RELATED APPLICATION

This application is based on and claims priority under 35 USC 119 from Japanese Patent Application No. 2025-044549 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information browsing systems require a user to read full-length texts, manually distill important points, and, when needed, rely on separate tools to translate and rephrase content for different comprehension levels. As the volume and diversity of digital information increase, users face significant cognitive and time burdens in extracting concise key points, adjusting the expression of summaries to match their own understanding level, and accessing content written in foreign languages. Furthermore, known systems generally do not provide an integrated mechanism in which a processor automatically acquires information from various information sources, preprocesses the information for use with a generative AI model, generates appropriate prompts for summarization, formats the summarized information into a user-friendly structure such as bullet points, interactively adjusts the summary according to user input, and translates the summarized information into different languages. Therefore, there is a need for a system that can centrally perform acquisition, preprocessing, generative-AI-based summarization, interactive adjustment of summary expression, and multilingual translation of summarized information, in order to reduce the burden on the user and to provide summaries that are both quickly understandable and customizable.

### SUMMARY

To solve the above-described problems, the invention provides a system comprising a processor, wherein the processor is configured to acquire information from an information source, convert the acquired information into text data and perform preprocessing on the text data, and generate a prompt for instructing a generative AI model to summarize information based on the preprocessed text data and input the prompt into the generative AI model. The processor is further configured to format summarized information obtained from the generative AI model into a predetermined format and transmit the formatted summarized information to a terminal of a user. In addition, the processor is configured to interactively adjust the summary of the information in accordance with user input, and to translate the summarized information into a different language. In one aspect, the processor is configured to use a prompt for instructing the generative AI model to analyze the information acquired from the information source and summarize key points of the information in a bullet-point format. In another aspect, the processor is configured to generate a prompt for instructing adjustment of an expression of the summary to correspond to different levels of understanding based on input from the user, and to apply a template selected according to a selection of the user. By these means, the system enables automatic generation of concise, structured summaries, interactive control over the style and comprehension level of the summaries, and multilingual access to the summarized information.

The term “system” refers to an arrangement of hardware and software components, including at least one processor and associated memory and communication interfaces, that cooperatively perform the processing defined in the claims.

The term “processor” refers to one or more hardware processing units, such as a CPU, GPU, ASIC, FPGA, or a combination thereof, capable of executing instructions to perform the functions described in the claims.

The term “information source” refers to any source from which information can be obtained, including but not limited to web servers, databases, file systems, content feeds, or application programming interfaces that provide digital content.

The term “information” refers to digital content obtained from an information source, including but not limited to articles, documents, posts, messages, or other textual or semi-structured data.

The term “text data” refers to data represented in a textual form suitable for natural language processing, including plain text and structured text formats obtained by converting information acquired from an information source.

The term “preprocessing” refers to processing performed on text data prior to input to a generative AI model, including operations such as cleaning, tokenization, normalization, segmentation, language detection, and removal of unnecessary elements.

The term “prompt” refers to data, including instructions, constraints, and optionally example texts, that is provided as input to a generative AI model to cause the generative AI model to perform a specific task, such as summarization or adjustment of expression.

The term “generative AI model” refers to a trained machine learning model capable of generating text or other content in response to a prompt, including but not limited to large language models and neural network-based text generation models.

The term “summarize” refers to the process of generating a shorter representation of information that preserves essential content, including key points, main ideas, or important facts, compared to the original information.

The term “summarized information” refers to information output by the generative AI model as a result of a summarization process, including condensed content in textual or structured form.

The term “predetermined format” refers to a format defined in advance for presenting summarized information, including but not limited to bullet-point lists, numbered lists, sections with headings, or templates specifying layout and style.

The term “terminal of a user” refers to any user-operated device capable of communicating with the system, including but not limited to a smartphone, tablet, personal computer, or other computing device with a display and network connectivity.

The term “interactively adjust” refers to modifying parameters, content, or expression of a summary in response to one or more inputs from the user during operation, such that the summary can be updated based on user preferences or selections.

The term “expression of the summary” refers to the linguistic style, tone, complexity, or phrasing used in the summarized information, including vocabulary level, sentence length, and degree of technicality.

The term “different levels of understanding” refers to varied comprehension levels of intended readers, including but not limited to levels suitable for children, middle-school students, general adults, or experts, each associated with corresponding complexity and terminology.

The term “template” refers to a predefined pattern or rule set specifying at least one of structure, style, tone, or vocabulary, which is applied to summarized information or prompts to control how the summary is expressed.

The term “bullet-point format” refers to a representation of summarized information in which key points are listed as discrete items, each item typically corresponding to a single main idea and visually distinguished by markers such as bullets or dashes.

The term “translate” refers to converting summarized information expressed in a first natural language into text expressed in a second natural language while preserving the meaning of the original summarized information.

The term “different language” refers to a natural language that is not the original language of the summarized information, such as translating from English to Japanese, Japanese to English, or between any other distinct language pair.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

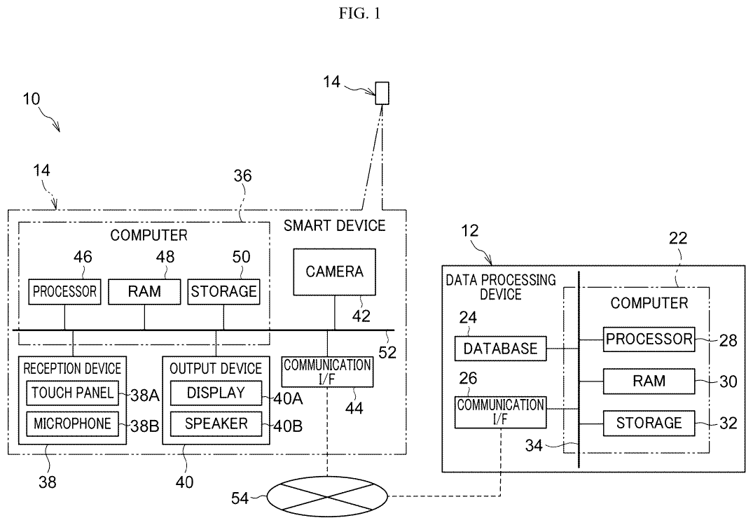

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

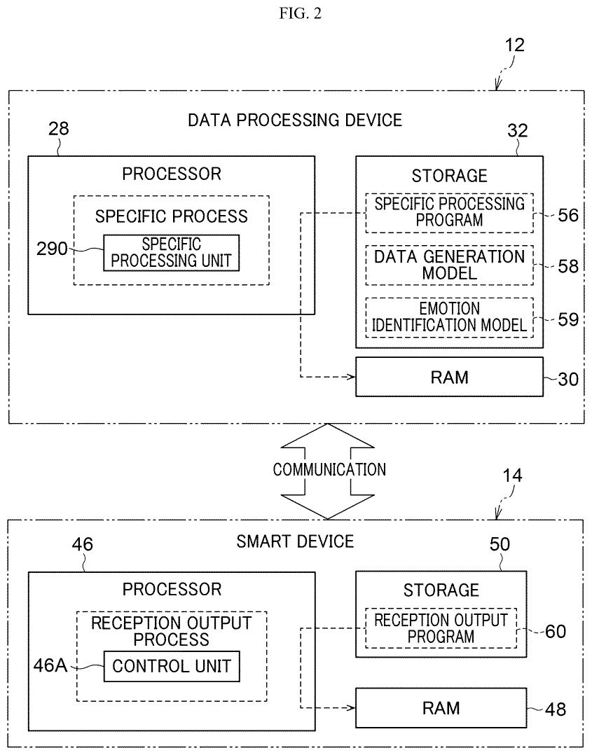

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In networked computing environments, large volumes of unstructured electronic information such as web pages, documents, and data feeds are continuously generated and distributed. Conventional server systems that provide summaries of such information typically rely on fixed rule-based extraction, static templates, or manually crafted summaries. These systems suffer from several technical deficiencies.

First, conventional systems lack a unified processing pipeline that robustly converts heterogeneous electronic formats (for example, markup documents and structured data) into normalized analysis text data suitable for automated summarization. As a result, servers must implement multiple ad hoc parsers, often causing increased processing latency, higher memory usage, and inconsistent extraction of body text across different sources.

Second, existing summarization services generally apply a single, pre-defined summarization style or compression ratio that does not adapt to different user comprehension levels, output languages, or presentation formats. The server typically treats user requests as one-shot operations and does not maintain rich dialogue context or iterative refinement state. This results in redundant recomputation, inefficient use of network and processing resources, and suboptimal summaries that fail to match the user's dynamic requirements.

Third, conventional systems do not effectively integrate generative AI models into the core server-side processing architecture as controllable components. In many cases, a generative model is invoked with a simple, static prompt, and the server does not programmatically construct and reconstruct prompt sentences in a structured manner based on dialogue history, previous outputs, and machine-detected characteristics of the input text. Consequently, the generative AI model is underutilized, leading to less accurate or less stable summaries and increased trial-and-error by users.

Fourth, existing approaches that provide multilingual summaries often treat summarization and translation as separate stages, without coordinated control at the server. This can introduce cumulative errors, duplicated processing, and increased latency, particularly when the server must handle many languages and diverse reading levels. The server also typically lacks automatic language determination and systematic selection of translation behavior as part of the same computational workflow that governs summarization.

Accordingly, there is a need for an improved computer-implemented system in which a server processor (i) acquires heterogeneous electronic information from network sources, (ii) converts such information into normalized analysis text data through structured document analysis and string normalization, (iii) programmatically constructs prompt sentences in a natural language that encode summary target text, output format, output language, comprehension level, and information density, (iv) interacts with a generative AI model in a stateful, iterative fashion based on dialogue history and prior summary results, and (v) integrates language determination and translation to produce dynamically adjustable, multilingual summaries. Such a system should improve the technical functioning of the server by reducing ad hoc parsing logic, enabling consistent data preparation, optimizing network and compute utilization through controlled prompt construction, and providing more accurate and user-adaptive summaries with fewer computational cycles.

The specific processing by the specific processing unit 290 of the data processing device 12 in Example 1 is realized by the following means.

The present invention provides a server comprising a processor and a memory storing instructions, wherein the instructions, when executed by the processor, cause the processor to acquire electronic information from at least one information providing device via a communication network; to parse the acquired electronic information using at least one structured document analysis program or data structure analysis program to extract body text, delete unnecessary data, and perform character string normalization to generate analysis text data; to construct, based on the analysis text data and summary conditions received from a user terminal, a prompt sentence expressed in a natural language, the prompt sentence including instructions specifying at least a summary target text, an output format, an output language, a comprehension level, and an amount of information, and to generate input data including the prompt sentence and transmit the input data to a generative AI model; to receive a summary result from the generative AI model, to analyze the summary result, and to generate summary text data in a predetermined display format by correcting line breaks and item symbols such that the summary text data is provided as a list in at least one of a bullet list format and a numbered list format; to generate response data including the summary text data and to transmit the response data to the user terminal using a communication protocol; to obtain, as dialogue history, additional instructions or correction instructions that are successively input from the user terminal, to reconstruct a further prompt sentence including the dialogue history and at least one previous summary result, and to re-transmit the further prompt sentence to the generative AI model so as to progressively update summary content or expressions based on multiple responses; and to determine a language of the summary text data and convert the summary text data into a different language specified by the user using at least one language determination program or translation program. This enables the server to implement an integrated, computer-implemented summarization and translation pipeline that normalizes heterogeneous input data, programmatically controls a generative AI model through dynamically constructed prompt sentences, maintains dialogue-aware context for iterative refinement, and generates user-adaptive, multilingual summaries with improved processing efficiency and improved consistency compared to conventional systems.

The term “electronic information” refers to digital data obtained from an information providing device, including but not limited to markup documents, structured data, text files, and other machine-readable content that can be transmitted over a communication network.

The term “information providing device” refers to any computing device or system that supplies electronic information via a communication network, including but not limited to web servers, application servers, database servers, and network-based content distribution systems.

The term “communication network” refers to any wired or wireless data communication infrastructure that enables data transfer between the server, the information providing device, and a user terminal, including but not limited to local area networks, wide area networks, and public data networks.

The term “structured document analysis program” refers to a software component configured to parse and analyze documents having a structured or semi-structured format, such as markup documents, to identify and extract specific elements including body text, headings, and metadata.

The term “data structure analysis program” refers to a software component configured to parse and analyze electronically stored data represented in a structured format, such as records, fields, or key-value pairs, in order to extract target textual or contextual information.

The term “body text” refers to a subset of electronic information representing main content intended for human reading, excluding navigation elements, scripts, advertisements, and other ancillary or non-content elements.

The term “unnecessary data” refers to portions of electronic information that are not relevant to a summarization or translation task, including but not limited to markup tags, scripts, style definitions, navigation menus, tracking elements, and advertising content.

The term “character string normalization” refers to a process of transforming textual data into a standardized format, including but not limited to normalization of whitespace, removal of control characters, canonicalization of character encodings, and unification of punctuation or formatting.

The term “analysis text data” refers to text that has been extracted and normalized from electronic information and that is prepared as input for subsequent computational processing, including summarization and translation.

The term “summary conditions” refers to parameters or constraints provided by a user or predefined by the system, including but not limited to summary length, number of items, output format, output language, target comprehension level, and degree of detail.

The term “prompt sentence” refers to text expressed in a natural language that encodes instructions or constraints for a generative AI model, including specifications of a summary target text, an output format, an output language, a comprehension level, and an amount of information.

The term “input data including the prompt sentence” refers to digital data transmitted to a generative AI model, the data comprising at least one prompt sentence and optionally including associated analysis text data and control parameters.

The term “generative AI model” refers to a computational model for natural language processing that receives input data including a prompt sentence and generates output text such as summaries, translations, or reformulations based on learned parameters.

The term “summary result” refers to output text generated by a generative AI model in response to input data including a prompt sentence, the output text representing a condensed form of analysis text data.

The term “summary text data” refers to post-processed summary result data that has been formatted or adjusted by the server to conform to a predetermined display format.

The term “predetermined display format” refers to a predefined representation style for summary text data, including but not limited to list-based formats, paragraph-based formats, or other layout structures suitable for display on a user terminal.

The term “list format” refers to a representation of summary text data in which individual summary elements are separated into distinct items, including at least a bullet list format or a numbered list format.

The term “bullet list format” refers to a list format in which each item is preceded by a graphical or textual bullet indicator rather than an explicit numeric index.

The term “numbered list format” refers to a list format in which each item is preceded by a sequential numeric or alphanumeric index.

The term “response data” refers to electronic data generated by the server for transmission to a user terminal, the data including at least summary text data and optionally including metadata or status information.

The term “communication protocol” refers to a set of rules and formats governing the transmission and reception of data between the server and a user terminal over a communication network.

The term “user terminal” refers to an electronic device operated by a user that is capable of sending requests to and receiving responses from the server, including but not limited to a personal computer, a tablet device, a smartphone, or another network-capable device.

The term “dialogue history” refers to a record of sequential inputs and outputs exchanged between a user terminal and the server, including additional instructions, correction instructions, and previously generated summary results.

The term “additional instructions” refers to user-provided inputs that request further operations on existing summary text data, including but not limited to extensions, clarifications, or changes in style or length.

The term “correction instructions” refers to user-provided inputs that indicate desired modifications or corrections to previously generated summary results, including but not limited to adjustments in accuracy, tone, detail level, or language.

The term “previous summary result” refers to a summary result or summary text data that has been generated in response to an earlier prompt sentence and that is used as context for a subsequent refinement operation.

The term “progressively update summary content or expressions” refers to performing iterative refinement of summary text data over multiple interactions, such that content selection, wording, or structure is modified based on dialogue history and new instructions.

The term “language determination program” refers to a software component configured to detect or infer a language of given text data using computational techniques such as statistical analysis, pattern matching, or machine learning.

The term “translation program” refers to a software component configured to convert text from a source language to a target language using rule-based methods, statistical methods, neural methods, or combinations thereof.

The term “different language specified by the user” refers to a target natural language indicated by the user through a user terminal, which is distinct from at least one language of the input analysis text data or the initial summary result.

The term “target reader group” refers to a category of intended readers characterized by attributes such as age, education level, or domain expertise, used to determine a desired comprehension level for summary generation.

The term “allowable word count” refers to a constraint on the maximum or approximate number of words that may be included in generated summary text data.

The term “technical terms” refers to domain-specific words or phrases that are characteristic of particular fields of knowledge and that may require specialized understanding.

The term “level of explanatory detail” refers to a degree of elaboration or depth with which concepts are described in the generated summary, including levels such as brief, standard, or detailed.

The term “template” refers to a predefined pattern or structure for prompt sentences, the pattern including placeholders for parameters such as target reader group, allowable word count, technical term usage, and explanatory detail.

The term “template group” refers to a set of templates that are associated with common parameter combinations or use cases and that can be selectively applied based on user input or system conditions.

The term “natural language instruction” refers to a portion of a prompt sentence expressed in a human language that specifies operational behavior, constraints, or preferences for the generative AI model.

The term “comprehension level” refers to a degree of complexity and abstraction at which information is expressed in the summary, corresponding to a target reader group's expected understanding.

In one embodiment, a server implements the claimed system as a network-based summarization and translation platform. The server comprises at least one processor, a main memory, a non-volatile storage device, and a network interface. The server executes an operating system such as a UNIX-like operating system and one or more application programs implemented, for example, in a scripting language runtime such as a Python runtime environment or a JavaScript runtime environment. The server further executes libraries for structured document analysis, such as an HTML parsing library corresponding to a document object model parser, and libraries for HTTP communication and JSON processing.

The server cooperates with at least one terminal. The terminal comprises a processor, a memory, a display device, a user input device such as a touchscreen or keyboard, and a network interface. The terminal executes a web browser or a native application that presents a graphical user interface for receiving user input and displaying summary results. The user interacts with the terminal to submit source identifiers (for example, network resource locators) or raw text, to specify summary conditions, and to refine summary results through interactive instructions.

The server uses a structured document analysis program, such as a parser corresponding to a markup-document parsing library, to transform electronic information received from an information providing device into analysis text data. The server uses an HTTP client library to retrieve electronic information over a communication network. When the electronic information is formatted as a markup document, the server uses the structured document analysis program to construct a document tree, to identify content-bearing elements (for example, elements whose tag type or class attributes match known content patterns), and to exclude irrelevant elements such as scripting blocks, style definitions, navigation frames, and advertising sections. The server performs character string normalization, including conversion to a standard character encoding, normalization of whitespace, and removal of control characters, by applying text processing libraries and regular expression engines.

The server stores the normalized analysis text data in memory using a specific data structure, such as a text buffer associated with metadata describing detected language, source type, and estimated length. The server may use a language determination program that applies statistical language models or character n-gram distributions to classify the language of the analysis text data. The server may maintain a metadata record in a key-value store or relational database to associate each analysis text buffer with its language, original source, timestamp, and user-specific summary conditions.

The server constructs a prompt sentence in a natural language as a function of the analysis text data and the summary conditions received from the terminal. The server represents the summary conditions internally as parameter values including at least: a target reader group identifier, an allowable word count or item count, a flag indicating whether technical terms should be preserved or simplified, an output language identifier, and a level of explanatory detail. The server selects a template from a plurality of prompt templates stored in a template repository. Each template is a natural language pattern that includes placeholders for the parameter values. For example, the server may select a template corresponding to a high-level explanation mode and instantiate the template as follows:
“Summarize the following article in 5 bullet points, using plain language suitable for a high-school student. Focus on the main events and their causes.
[article text here]”
In another example, the server may select a template emphasizing translation and technical brevity, and instantiate the template as follows:
“Translate the following Japanese article into English and then provide a 3-point bullet summary in English, highlighting only the key factual points without additional commentary.
[article text here]”
In yet another example, the server may select a template for further simplification of an existing summary, and instantiate the template as follows:
“Below is an existing bullet-point summary. Rewrite the summary in simpler English suitable for a middle-school student. Keep at most 3 bullet points and preserve the key facts.
[current summary here]”

The server appends the analysis text data or existing summary data to the instantiated prompt sentence to generate input data for a generative AI model. The server may segment the analysis text data into portions that satisfy a token-length constraint by using a token estimation module that approximates the number of tokens based on character counts and language-specific rules. The server thereby avoids exceeding maximum context limits of the generative AI model and reduces redundant data transmission over the communication network.

The server transmits the input data to the generative AI model using a network interface and an encrypted application-layer protocol. The generative AI model is, in one embodiment, a multi-layer neural network implementing a transformer architecture. The generative AI model includes an input embedding layer that converts tokens into dense vectors, a plurality of encoder-decoder or decoder-only blocks that include multi-head self-attention mechanisms, feed-forward networks, and layer normalization units, and an output projection layer that maps internal hidden states to probability distributions over a token vocabulary.

The generative AI model has been trained in advance using a large corpus of natural language texts. During training, the generative AI model receives sequences of tokens and is optimized to predict subsequent tokens by minimizing a loss function such as a cross-entropy loss between predicted token distributions and ground-truth tokens. The model training uses gradient-based optimization, such as stochastic gradient descent with adaptive moment estimation, to update weight parameters of the attention layers and feed-forward layers. The model may employ data augmentation strategies such as random masking of tokens or reordering of paragraphs to improve robustness to noisy or partially structured inputs.

The server receives, as output from the generative AI model, a sequence of tokens representing a summary or translated text. The server uses a decoding algorithm, such as greedy decoding or beam search with a specified beam width, to obtain a deterministic text output. The server then parses the generated text to enforce a target list format by detecting line breaks, bullet markers, and numbering patterns. When the generated text does not strictly adhere to a specified output format, the server applies list-normalization logic to reinsert or correct bullet symbols, align indentation, and enforce a maximum number of items. This server-side post-processing contributes to technical improvement by compensating for variability in the generative AI model's output while ensuring that the terminal receives structurally consistent data suitable for efficient rendering.

The server stores the generated summary text data with references to the corresponding dialogue history, including previous prompt sentences and summary results. The server represents the dialogue history, for example, as an ordered list of interaction records, each record containing the user's instruction text, the constructed prompt sentence, and the corresponding summary text data. This explicit dialogue state representation enables the server to reconstruct context-aware prompt sentences that incorporate both the current user instruction and prior outputs. For example, when the user requests clarification of a specific bullet point, the server can insert the previous summary result and the user's correction instruction into a new prompt sentence that explicitly instructs the generative AI model to refine only the relevant portion, thereby reducing unnecessary recomputation on unrelated sections.

The terminal receives summary text data and associated metadata from the server. The terminal stores the received data in a local memory buffer and renders the data on the display device. The terminal may use a markup rendering engine to display bullet lists and numbered lists as visual list elements, and may provide interactive controls such as buttons labeled “Shorten,” “Explain More,” or “Change Language.” When the user activates such controls, the terminal generates new instruction text that is transmitted back to the server. The user thereby interacts with the summary in an iterative, dialogue-style workflow.

The user uses the terminal to specify target reader groups, such as “general public,” “high-school students,” or “technical experts.” The terminal may internally map these categories to numerical identifiers that are transmitted to the server as part of the summary conditions. The server uses the identifiers to select templates and to adjust parameters such as allowable word count and explanation detail. Through this mapping, the user indirectly controls the complexity of generated summaries, while the server enforces consistent parameterization and efficient reuse of templates and generative AI model calls.

The server, in some embodiments, integrates a translation program separate from the generative AI model. The server applies the language determination program to detect that the analysis text data or summary text data is in a first language and that the user has requested output in a second language. The server may then either include translation instructions in the prompt sentence to the generative AI model, or route the text through a dedicated machine translation engine that supports neural sequence-to-sequence translation. In either case, the server ensures that translation and summarization are coordinated at the level of prompt sentence construction and data flow, thus avoiding redundant preprocessing and reducing network traffic by minimizing the number of distinct service calls.

The server improves computer technology in several ways. By normalizing heterogeneous source formats into a unified analysis text data structure using structured document analysis programs and character string normalization, the server reduces the number of parser implementations and associated error paths, which in turn reduces processing time and memory fragmentation. By constructing parameterized prompt sentences that embed structured summary conditions, the server reduces the need for multiple ad hoc summarization rules and allows a single generative AI model to handle diverse summarization tasks. The server's explicit dialogue history representation and context-aware prompt reconstruction reduce redundant generation of entire summaries when only partial modifications are requested, thereby decreasing compute time on the generative AI model hardware and reducing communication bandwidth usage.

The server controls the generative AI model not merely as a black-box automation of human summarization, but as a configurable computational module that operates under non-conventional prompt design and iterative refinement rules. For example, the server constrains token usage through chunking and parameterized maximum lengths, applies structured templates that encode domain-specific summarization patterns, and uses machine-detected language and metadata to condition translation and summarization jointly. These design choices provide technical effects such as improved latency, more stable output structure, and reduced error propagation across multiple interactions.

The server may implement alternative embodiments of the generative AI model. In one embodiment, the server interfaces with an external inference service accessible via a network, where the generative AI model runs on specialized hardware accelerators such as graphics processing units or tensor processing units. In another embodiment, the server locally hosts a smaller transformer model optimized for short texts. The server may use model selection rules that analyze input length, domain tags, and latency constraints to select between models, thereby further improving computational efficiency.

The server may also implement alternative template sets and parameterization strategies. For instance, in a legal-domain embodiment, the server may store templates that explicitly instruct extraction of contractual obligations, parties, and effective dates. A suitable prompt sentence may be:
“Summarize the following contract in no more than 7 bullet points, focusing on the parties, key obligations, payment terms, and termination conditions. Use clear, neutral language.
[contract text here]”
In a scientific-domain embodiment, the server may store templates that emphasize experimental setup and results:
“Summarize the following research article in 5 bullet points, highlighting the research purpose, methods, key results, and conclusions. Minimize jargon where possible.
[article text here]”

In each case, the server modifies the internal configuration of summary conditions and prompt templates without altering the overall architectural design, thus supporting multiple use cases while maintaining the technical advantages of unified parsing, prompt management, and iterative refinement.

The terminal, in some embodiments, caches recently received summary text data and associated dialogue history entries in local storage. The terminal may then request only incremental updates from the server when the user modifies summary conditions.

This caching reduces communication load on the network and improves responsiveness from the perspective of the user, while the server maintains canonical copies of the dialogue history for consistent processing.

The user, using the terminal, can apply this system to various real-world scenarios, such as rapid comprehension of continuously updated news feeds, multilingual briefings for international teams, and technical abstraction of long-form documentation.

By offloading complex parsing, summarization, and translation steps to a server that executes specialized software components and a generative AI model with a transformer architecture, the user benefits from improved processing speed, consistency, and adaptability that are not achievable with manual reading and summarization alone.

Through these embodiments, the server, the terminal, and the user interact in a coordinated manner to implement the claimed system. The server performs concrete technical operations on electronic information, uses specific hardware and software components including structured document analysis programs and a transformer-based generative AI model, manages structured data flows and dialogue histories, and generates normalized, parameterized summaries and translations with verifiable improvements in efficiency, consistency, and computational resource utilization.

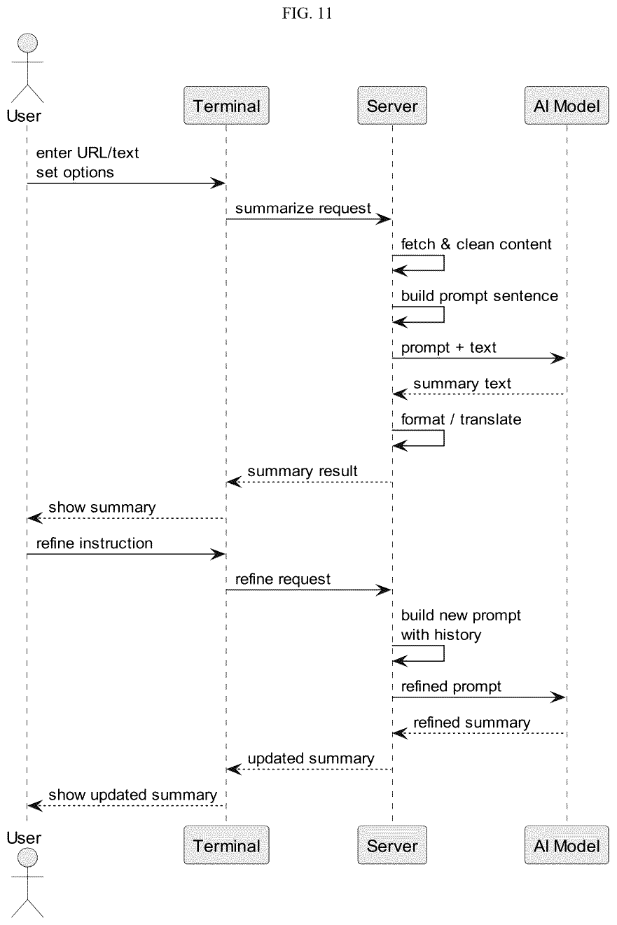

The following describes the processing flow using FIG. 11.

### Step 1:

The user operates the terminal to specify a source of information and summary conditions. The terminal receives as input a network resource locator or pasted text, together with user-selected options such as desired number of bullet points, target language, and target reader group. The terminal performs validation on the input (for example, syntax checking of the network resource locator and range checking of option values) and converts the user selections into structured parameters. The terminal outputs a request message including the source identifier or raw text and the structured summary conditions, and transmits this request message to the server via a communication network.

### Step 2:

The server receives the request message from the terminal. The server parses the message as input, extracting the source identifier or raw text and the structured summary conditions. When the input includes a source identifier, the server uses an HTTP client library to send a request to an information providing device, and receives electronic information such as a markup document or structured data. When the input includes raw text instead of a source identifier, the server directly treats this raw text as electronic information. The server outputs the acquired electronic information together with the associated summary conditions for subsequent processing.

### Step 3:

The server performs preprocessing on the acquired electronic information. The server uses the electronic information as input and determines its format from metadata such as content type headers or file extension. When the format is a markup document, the server uses a structured document analysis program to construct a document tree, traverses nodes to locate content-bearing regions, and removes non-content nodes such as script and style elements. When the format is structured data, the server uses a data structure analysis program to extract relevant text fields. The server then performs character string normalization by converting text to a standard encoding, compressing multiple whitespace characters into single spaces, and removing control characters. The server outputs analysis text data that consists of normalized body text and associated metadata such as detected language and estimated length.

### Step 4:

The server determines language and updates summary conditions. The server receives the analysis text data as input and applies a language determination program that computes language probabilities based on character n-gram statistics or model-based classification. The server compares the detected language with the target output language specified in the summary conditions. When the detected language differs from the target language, the server sets a translation-required flag in the summary conditions. The server outputs updated summary conditions together with the analysis text data, indicating whether translation should be incorporated into subsequent summarization processing.

### Step 5:

The server generates a prompt sentence by combining the analysis text data and the summary conditions. The server uses the analysis text data and updated summary conditions as input and selects an appropriate template from a repository of natural language templates using parameters such as target reader group, allowable word count or item count, and translation-required flag. The server replaces placeholders in the selected template with concrete values derived from the summary conditions (for example, inserting the number of bullet points and the description of the target reader group). The server then appends the analysis text data or, when refining a prior summary, the existing summary text to the instantiated template. The server outputs a prompt sentence and associated text as input data for the generative AI model.

### Step 6:

The server segments the input data to satisfy model constraints. The server uses the constructed prompt sentence and associated text as input and estimates the number of tokens using a token estimation module that maps character length and language characteristics to approximate token counts. When the estimated token count exceeds a predefined threshold for the generative AI model, the server divides the associated text into multiple segments in a manner that preserves sentence boundaries. The server generates multiple input data instances, each consisting of the prompt sentence combined with a different text segment, or, when possible, a shortened representation of the text. The server outputs one or more finalized input data instances, each of which is configured to fall within the generative AI model's context limit.

### Step 7:

The server transmits the input data to the generative AI model and receives a summary result. The server uses the finalized input data as input and sends it via a network interface to a generative AI model endpoint using an encrypted protocol. The generative AI model processes the input data using a transformer architecture, internally applying token embedding, multi-head self-attention, feed-forward layers, and output projection to compute a probability distribution over tokens for each step of decoding. The generative AI model generates a sequence of tokens corresponding to a summary or combined translation-and-summary output. The server receives the output tokens as part of a response message, decodes the tokens into text using a decoding algorithm such as greedy decoding or beam search, and outputs raw summary text as a summary result.

### Step 8:

The server post-processes the summary result into a predetermined display format. The server receives the raw summary text as input and analyzes its structure by detecting line breaks, bullet markers, and numbering patterns. The server applies list-normalization logic to enforce a list format, inserting or correcting bullet symbols or numeric prefixes when they are missing or inconsistent. The server truncates or merges list items when their count exceeds a limit specified by the summary conditions, and adjusts spacing and punctuation to conform to a predetermined style. The server outputs normalized summary text data formatted as a bullet list or numbered list and associates this data with metadata such as original source identifier and timestamp.

### Step 9:

The server applies translation processing when required. The server uses the normalized summary text data and the translation-required flag in the summary conditions as input. When the flag is set, the server either constructs a new prompt sentence instructing translation and sends the normalized summary text data to the generative AI model, or routes the text to a translation program that performs neural sequence-to-sequence translation. The server obtains translated text from the generative AI model or translation program, and then reapplies list-normalization if necessary to preserve the list structure. The server outputs final summary text data in the target language specified by the user.

### Step 10:

The server associates the summary text data with dialogue history and prepares response data. The server receives the final summary text data as input and creates or updates a dialogue record that contains the current prompt sentence, the summary text data, and any prior interaction entries. The server stores this dialogue history in a database or memory structure indexed by a session identifier. The server then constructs response data that includes the final summary text data, metadata such as detected language and target reader group, and an identifier for the dialogue session. The server outputs the response data for transmission to the terminal.

### Step 11:

The terminal receives and renders the response data. The terminal uses the response data from the server as input and parses fields containing the summary text data and metadata. The terminal maps the list items in the summary text data to graphical list components, such as bullet lists or numbered lists, and renders them on the display device with appropriate fonts and spacing. The terminal also displays control elements that allow the user to request further operations such as shortening, elaboration, or translation changes. The terminal outputs a visual representation of the summary to the display and holds the underlying data in local memory for subsequent user interactions.

### Step 12:

The user reviews the summary and initiates interactive refinement. The user views the visual representation of the summary on the terminal and decides whether further refinement is desired. The user provides additional instructions, such as “Rewrite this summary for a middle-school student” or “Explain point 3 in more detail,” by operating input controls on the terminal. The terminal receives these instructions as input, converts them into structured refinement parameters and natural language instruction text, and outputs a new request message to the server that includes the dialogue session identifier, the current summary text, and the new user instruction.

### Step 13:

The server reconstructs a context-aware prompt sentence for refinement. The server receives the refinement request and treats the dialogue session identifier, current summary text, and user instruction as input. The server retrieves the corresponding dialogue history, which includes previous prompt sentences and summary results, and constructs a new prompt sentence that explicitly references the existing summary and the user instruction. For example, the server may generate a prompt sentence of the form: “Below is an existing bullet-point summary. Rewrite it in simpler English, keeping at most 3 bullet points and preserving key facts.” The server appends the current summary text after this prompt sentence. The server outputs refined input data for the generative AI model, thereby enabling iterative updates that focus on requested changes while reusing prior computational results.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information delivery systems that summarize articles for users often rely on fixed rule-based algorithms or static templates executed on general-purpose computers. Such systems typically operate in a pipeline where retrieval, preprocessing, summarization, formatting, and translation are implemented as loosely coupled modules that are not optimized as a whole with respect to computational efficiency, latency, or responsiveness to user interaction. As a result, these systems exhibit several technical deficiencies at the computer-architecture and system-operation level.

First, in many existing systems, the processor treats summarization as an isolated batch process that operates on large text blocks without adaptive control of input size, prompt structure, or output constraints. This causes inefficient use of processing resources in the server, including excess consumption of memory and processor cycles, and can lead to timeouts or degraded responsiveness when a large number of users simultaneously request summaries. In addition, the systems often do not standardize the format of the generative model's output into a machine-friendly, bullet-point data structure suitable for low-latency rendering on resource-constrained user terminals. This leads to additional ad hoc client-side parsing and formatting overhead, which increases end-to-end latency and degrades user experience, particularly on mobile terminals.

Second, conventional approaches typically do not integrate user interaction feedback, such as changes in article category, summarization style, or comprehension level, into a coherent, dynamically maintained prompt-generation mechanism. Instead, changes in user preferences may trigger a complete re-execution of the entire summarization pipeline from scratch, without reusing intermediate data or optimizing prompt sentences in view of the updated parameters. This leads to redundant processing, additional network traffic, and increased server load. The lack of a structured, server-side mechanism for composing and updating prompt sentences means that the generative model is not efficiently guided, and may generate verbose, inconsistent, or poorly structured summaries, which in turn require more bandwidth and more rendering work on the user terminal.

Third, existing systems often handle multilingual content using separate translation workflows that are not closely integrated with the summarization and formatting logic. In many cases, translation is performed either only on full-length articles or only on final summaries, without a coordinated strategy to minimize computational cost and latency. When translation is decoupled from the prompt-generation and summarization processes, the server must repeatedly retrieve and transform similar data, resulting in duplicated processing and inefficient utilization of memory and network resources. This makes it difficult to provide a consistent, low-latency user interface where bullet-point summaries and associated media can be scrolled continuously across different languages.

Fourth, traditional user interfaces tend to request and display summaries in discrete pages instead of a continuous, scroll-based feed. The server is not optimized to output summary data structures that are directly consumable by a continuous scrolling interface, and therefore must perform additional formatting and pagination steps or offload such processing to the user terminal. This causes fragmented data transmission, additional state management overhead on both server and client, and suboptimal use of cache and network resources, especially when many small requests are repeatedly issued as the user scrolls.

Accordingly, there is a need for a technical solution that improves the functioning of the server and its interaction with user terminals by: (i) tightly integrating retrieval, preprocessing, optional translation, prompt generation, generative summarization, post-processing, and formatting into a unified, processor-executed workflow; (ii) configuring the processor to generate structured prompt sentences that explicitly instruct a generative AI model to output compact bullet-point summaries under controllable constraints; (iii) enabling dynamic re-summarization based on interactive user input without redoing unnecessary processing; and (iv) providing summary display data structures that are natively suitable for continuous vertical scrolling on user terminals. Such a solution should reduce overall computational overhead, improve latency and bandwidth usage, and provide a technically improved, flexible, and multilingual summarization pipeline that better leverages the capabilities of a generative AI model in a computer-implemented environment.

The specific processing by the specific processing unit 290 of the data processing device 12 in Application Example 1 is realized by the following means.

The present invention provides a server comprising a processor configured to receive, from a user terminal, request information including at least an article category, a summarization style, a display language, and browsing status; to search, based on the request information, an information source to retrieve a plurality of information items, to extract and rank the information items using attribute information, and to select at least one information item as a summarization target; to acquire text data and media data from the summarization target, and to perform preprocessing on the text data including at least syntactic analysis, removal of unnecessary information, and language determination; to execute, based on a result of the language determination, machine translation to convert the text data or the preprocessed text data into a language corresponding to the display language of the user terminal; to generate, based on the article category and the summarization style included in the request information and based on the preprocessed text data or the translated text data, a prompt sentence that instructs a generative AI model to perform key point extraction and to generate a summary in a bullet-point format; to input the prompt sentence and the text data into the generative AI model and obtain summary text output from the generative AI model; to analyze the summary text to divide and format the summary text into individual bullet-point elements, to control a number of the bullet-point elements and unify expressions of the bullet-point elements, and to associate the bullet-point elements with the media data to generate a summary display data structure suitable for continuous vertical scrolling; to transmit the summary display data structure to the user terminal as screen configuration information; to receive, from the user terminal, interactive update input regarding at least one of the article category, the summarization style, and a comprehension level, and dynamically modify the prompt sentence according to the update input to execute re-summarization processing; and to perform translation processing to mutually convert the summary text and the summary display data structure among a plurality of languages and to transmit a result of the translation processing to the user terminal. This enables a technically improved computer-implemented summarization pipeline in which the server efficiently orchestrates retrieval, language processing, prompt sentence generation, generative AI inference, and structured output formatting, thereby reducing redundant processing, lowering latency and bandwidth consumption, and providing dynamically adjustable, multilingual bullet-point summaries that are directly optimized for continuous scrolling display on user terminals.

The term “processor” refers to a hardware computing unit or a group of hardware computing units, including at least one central processing unit or processing core, configured to execute instructions stored in a memory to perform data processing operations as described herein.

The term “user terminal” refers to an electronic device operated by a user, including but not limited to a smartphone, tablet, wearable device, head-mounted display, or personal computer, that is configured to communicate with the server over a network and to present information on a display.

The term “request information” refers to data transmitted from the user terminal to the server, the data including at least an indication of an article category, a summarization style, a display language, and browsing status, and optionally including user identification information, device information, and interaction history.

The term “article category” refers to a classification label that indicates a type or topic of content, such as technology, finance, sports, entertainment, or politics, and that is used by the server to search and filter information items from one or more information sources.

The term “summarization style” refers to a set of parameters or attributes defining how a summary should be expressed, including at least tone, formality level, level of detail, and target audience characteristics, and that influences the content and wording of a summary generated by a generative AI model.

The term “display language” refers to a natural language selected or used by the user terminal for presenting text to a user, such as English, Japanese, or other human languages, and that is used by the server as a target language for translation and output formatting.

The term “browsing status” refers to state information associated with a current viewing session on the user terminal, including at least a scroll position, a page index, or a set of already displayed items, and that is used by the server to determine which additional information items should be summarized and transmitted.

The term “information source” refers to any data repository or data feed from which content can be acquired, including but not limited to databases, file systems, syndicated feeds, content management systems, and external network services that store or provide articles or other information items.

The term “information item” refers to a single unit of content retrieved from an information source, including at least textual content and optionally metadata such as title, author, publication time, category labels, and associated media data.

The term “attribute information” refers to metadata associated with an information item, including but not limited to category, publication time, language, popularity metrics, source identifier, and user relevance scores, and that is used by the server to extract, rank, and select information items.

The term “summarization target” refers to an information item or a subset of content from an information item that has been selected by the server to undergo summarization processing by the generative AI model.

The term “text data” refers to a sequence of characters representing content in a natural language, including at least a body of an article, a title, and other textual fields, in a machine-readable format suitable for processing by the server and by the generative AI model.

The term “media data” refers to non-textual content associated with an information item, including but not limited to images, videos, audio data, and corresponding identifiers or resource locations, that can be associated with a summary for display on a user terminal.

The term “preprocessing” refers to a set of operations applied to text data by the server prior to summarization, including at least syntactic analysis, removal of unnecessary information, normalization of characters and formatting, and determination of a language of the text.

The term “syntactic analysis” refers to a natural language processing operation that analyzes grammatical structure of text data, such as tokenization, part-of-speech tagging, or dependency parsing, to facilitate subsequent summarization or translation.

The term “removal of unnecessary information” refers to operations that eliminate elements not needed for summarization, including but not limited to markup tags, scripts, advertisements, navigation text, boilerplate text, and duplicated segments.

The term “language determination” refers to a process in which the server identifies a natural language of text data using metadata or automated language detection, and outputs a language code or equivalent representation.

The term “machine translation” refers to an automated process in which text data in a source language is converted into corresponding text data in a target language by a computer-implemented translation model or translation engine.

The term “generative AI model” refers to a machine learning model configured to generate natural language text in response to input, the model being trained on large-scale text data and implemented using one or more neural networks, such as transformer-based networks, to perform tasks including summarization and key point extraction.

The term “prompt sentence” refers to a structured input text provided to the generative AI model, including explicit instructions, constraints, and contextual information that guide the generative AI model to produce a desired output, such as a bullet-point summary.

The term “key point extraction” refers to an operation in which significant or salient pieces of information are identified and selected from text data, including main events, principal entities, causes, effects, and other content deemed central to understanding the text.

The term “bullet-point format” refers to a structured textual representation in which individual summary elements are separated into discrete items, each preceded by a bullet symbol, number, or equivalent marker, to facilitate scanning and display.

The term “summary text” refers to text generated by the generative AI model, the text representing a condensed version of the original text data and including at least one bullet-point element produced according to the prompt sentence.

The term “bullet-point element” refers to an individual item within a bullet-point format, corresponding to a single summarized statement, fact, or concept extracted from the original text data.

The term “summary display data structure” refers to a machine-readable arrangement of data that represents a summary in a structured form, the arrangement including at least bullet-point elements, associated media references, and layout-related information suitable for rendering on a user terminal.

The term “continuous vertical scrolling” refers to an interaction mode on a user terminal in which content items are arranged in a vertical sequence and can be progressively displayed by moving a scroll position without discrete page transitions.

The term “interactive update input” refers to information sent from the user terminal to the server in response to user operations, the information indicating at least a modification to an article category, a summarization style, or a comprehension level, and serving as a basis for re-summarization.

The term “comprehension level” refers to an indication of a target difficulty or detail level of a summary, such as expert-oriented, general, or beginner-oriented, that affects the vocabulary, explanation depth, and assumed prior knowledge in the generated summary text.

The term “preference information” refers to data representing user preferences, including at least a comprehension level, a style type, and an interest field, and used by the server to control prompt sentence generation and to select a summary template.

The term “style type” refers to a classification of textual presentation, such as formal, neutral, casual, or friendly, that determines tone and wording in the generated summary text.

The term “interest field” refers to a thematic area or subject matter in which a user is particularly interested, such as a specific technology area or business domain, and that may influence article selection and emphasis within a summary.

The term “summary template” refers to a predefined structure or pattern that specifies how a summary should be organized and phrased, including rules about bullet-point ordering, introductory phrases, and emphasis, and that is applied to the output of the generative AI model.

The term “translation processing” refers to a sequence of operations in which the server converts text included in the summary text or in the summary display data structure from one language to another and integrates the translated content back into a form suitable for transmission and display.

The term “screen configuration information” refers to data specifying how content, including bullet-point elements and media data, is to be arranged, formatted, and presented on a display of the user terminal, in particular for continuous vertical scrolling.

In one embodiment, a server implements the claimed system using one or more general-purpose computing devices comprising at least one processor, a main memory, a non-volatile storage device, and a network interface. The server executes a server program stored in the non-volatile storage device and loaded into the main memory. The server program is implemented, for example, using a server-side framework such as a web application framework, and exposes an interface to one or more user terminals over a packet-switched network.

The server uses a relational or document-oriented data storage system as an information source for information items. The server, for example, accesses a database management system executing on the same hardware platform or on a separate storage server. The server stores, for each information item, at least text data representing a title and a body of an article, attribute information including a category label, a publication time, a language identifier, and popularity metrics, and media data including identifiers or resource locations of associated images and videos. The server organizes each information item as a record in a table or document collection, such that text data, attribute information, and media data can be retrieved and processed together.

The terminal operates as a user terminal that communicates with the server. The terminal includes at least one processor, a display, an input interface such as a touch panel or pointing device, a memory, and a wireless or wired network interface. The terminal executes an application program that issues request information to the server and renders summary display data structures received from the server. The user interacts with the terminal by operating the input interface to specify, for example, an article category, a summarization style, a display language, and a comprehension level.

The server uses text-processing software modules to preprocess text data acquired from the information source. The server may employ a natural language processing library to perform syntactic analysis, tokenization, sentence segmentation, and part-of-speech tagging. The server executes these operations on the processor by applying deterministic parsing algorithms and statistical models provided by the library to the text data stored in memory. The server further executes removal of unnecessary information by scanning the text data for markup tags, scripts, navigation blocks, advertisement markers, and boilerplate patterns, and removes such segments from the text data by string manipulation operations and regular-expression based filters.

The server determines a language of the text data either from stored attribute information or by executing a language identification algorithm. The server may apply a character n-gram model or a probabilistic classifier to compute, for each candidate language, a likelihood score based on the distribution of character sequences in the text data. The server selects the language with the highest score above a threshold as the language determination result and registers a language code in association with the text data.

When the determined language differs from the display language indicated in the request information, the server executes machine translation. The server transmits the text data or preprocessed text data to a translation engine and receives translated text data. The translation engine may be a neural machine translation system implementing an encoder-decoder architecture with an attention mechanism. The server stores both original and translated text data in memory and marks which version is to be used for subsequent prompt sentence generation. By executing translation at the server, the system reduces redundant translation requests from multiple terminals and centralizes language conversion in a single optimized component.

The server generates a prompt sentence as a structured natural language instruction to be input to a generative AI model. The server maintains a set of prompt templates in memory, each template parameterized by at least article category, summarization style, and comprehension level. The server selects an appropriate template based on request information and preference information, and then substitutes the selected article category, desired tone, and difficulty into placeholder positions within the template. The server then concatenates the instruction part and the relevant text data (either preprocessed or translated) into a single prompt sentence.

The server, for instance, generates a prompt sentence such as:
“Summarize the following technology news article in bullet points with a concise and neutral tone. Focus on the main facts and avoid subjective opinions: [article body].”

In another example, the server generates a prompt sentence such as:
“Summarize the following finance news article in bullet points using a casual and friendly tone. Explain complex terms in simple language as if talking to a non-expert friend: [article body].”

In a further example, the server generates a prompt sentence such as:
“Summarize the following translated news article about Japanese politics in bullet points for an international audience. Highlight the key events, main actors, and potential global impact: [translated article body].”

The server inputs the prompt sentence, together with identifiers for the applicable language and output constraints, into a generative AI model. In one embodiment, the generative AI model is implemented as a transformer-based neural network comprising an input embedding layer, multiple self-attention layers, feed-forward layers, and an output projection layer. The server invokes an inference engine that executes the neural network on specialized hardware such as a graphics processing unit in order to accelerate matrix multiplication and attention computation. The server encodes the prompt sentence into token identifiers, feeds the token identifiers into the neural network, and receives, as output, a sequence of token identifiers corresponding to the summary text.

The server configures the generative AI model with specific inference parameters, such as a maximum number of output tokens, a sampling temperature, and a top-k or top-p sampling strategy, to constrain the length and structure of the generated text. The server also encodes, as part of the prompt sentence, explicit instructions to output bullet-point items separated by line breaks and preceded by bullet markers. By doing so, the server causes the generative AI model to produce a summary text that is already formatted in a machine-parseable bullet-point structure, which reduces post-processing complexity and improves computational efficiency.

The server applies a deterministic post-processing procedure to the summary text. The server scans the summary text for lines beginning with a designated bullet marker, such as “-” or “•”, and splits the text accordingly into bullet-point elements. The server trims whitespace and removes duplicated or empty bullet-point elements. The server limits the number of bullet-point elements to a configured maximum by selecting, for example, the first N bullet-point elements or by computing a score for each bullet-point element based on the occurrence of high-priority terms derived from the original text data. The server then unifies expression patterns, such as enforcing that each bullet-point element begins with a capital letter and ends with a period, by applying text normalization rules.

The server constructs a summary display data structure that associates each bullet-point element with corresponding media data. The server, for example, stores each bullet-point element, together with identifiers or resource locations of images and videos, in an in-memory data structure such as a list of objects, each object including fields for the bullet-point text, media identifiers, article identifier, category, and language. The server further calculates layout-related information, such as an estimated number of display lines and thumbnail sizes, to be used by the terminal when rendering the summary. By precomputing this layout-related information, the server reduces the processing load on the terminal and stabilizes rendering performance on devices with limited computational resources.

The terminal receives the summary display data structure and renders the associated bullet-point elements and media data in a continuous vertical list. The terminal stores the summary display data structure in memory and uses a user interface framework to map each element of the data structure to a corresponding visual component. The terminal displays a subset of the components at any given time based on the current scroll position. When the user scrolls, the terminal updates the visible subset by reusing components and rebinding them to newly exposed elements of the summary display data structure. Because the server provides a normalized, consistent structure, the terminal can perform simple index-based access without executing complex parsing or reformatting operations.

The server receives interactive update input from the terminal when the user modifies at least one of the article category, summarization style, or comprehension level. The server stores preference information in association with a user identifier and uses the updated preference information on subsequent prompt sentence generation. The server can reuse previously retrieved and preprocessed text data for the same information item, and only changes the prompt sentence and generative AI model parameters according to the updated preferences. This selective reuse reduces redundant database queries, translation operations, and text preprocessing, thereby lowering server-side computational overhead and network traffic.

The server improves computer technology by orchestrating a non-conventional combination of retrieval, preprocessing, translation, prompt sentence generation, generative summarization, and structured formatting steps. The server modifies the internal behavior of the generative AI model by encoding explicit structural constraints and user-specific style parameters into the prompt sentence. This results in more compact and consistent bullet-point outputs, which directly reduce the number of tokens produced, shorten inference time, and lower bandwidth requirements. The server's structured post-processing and data structuring avoid on-device re-parsing, thus reducing the amount of memory and CPU cycles consumed by the terminal when rendering summaries.

The server uses a trained neural network in which weights have been optimized using a supervised learning or instruction-tuning process. During training, the server or an associated training environment supplies pairs of input prompt sentences and target bullet-point summaries to the neural network. The environment computes an error signal, for example a cross-entropy loss, between the predicted token distribution and the target distribution. The environment uses a gradient-based optimization method, such as stochastic gradient descent with adaptive learning rate, to update the weights of the neural network. The training process may include data augmentation techniques, such as rephrasing summaries or injecting noise into input text, and regularization techniques, such as dropout, to improve generalization. As a result, the generative AI model learns patterns that enable it to produce structurally stable bullet-point summaries when conditioned on the prompt sentences described herein.

The server selects specific attention-layer configurations, such as the number of layers, the number of attention heads, and the dimensionality of internal representations, to achieve a balance between accuracy and inference speed for the intended text length and usage pattern. For example, the server may use fewer layers and lower dimensionality for short articles, while using more layers and higher dimensionality for long or complex articles in a separate model variant. The server can store multiple model variants and choose among them based on article attributes, thereby optimizing computational resource usage.

The terminal benefits from the server's summary display data structure, which is optimized for continuous vertical scrolling. The terminal does not need to request a new page as the user scrolls; instead, the terminal can prefetch additional summary display data structures based on browsing status and append them to the existing list. The server, by tracking browsing status, can deliver only unseen items and avoid sending duplicate summaries. This reduces network utilization and latency, particularly in high-traffic environments and when multiple terminals simultaneously request content.

The server differs from traditional human-based summarization or simple automation of human tasks because the server uses internal representations, token-level constraints, and model-level architectural choices that are not practical for human operators. The server executes high-dimensional vector computations, attention-weighted context integration, and language-conditional generation, which follow rules embedded in the trained neural network weights rather than explicit human-crafted step-by-step rules. The prompt sentence design and server-side post-processing create a closed feedback loop between model output format and subsequent data-structure construction, resulting in a non-conventional processing pipeline that improves the overall performance of the computer system rather than merely replacing human reading and summarization.

In another embodiment, the server stores an alternative set of prompt templates and summary templates tailored to different output devices, such as small-screen wearable devices versus large-screen computers. The server can generate shorter or longer bullet-point elements, adjust the number of elements, and modify the level of detail based on terminal capabilities stored in device profiles. The terminal, in turn, can advertise its display resolution, available memory, and processing capacity, and the server uses this information to adjust summarization style and layout parameters. This device-aware adaptation reduces rendering overhead and network usage, because the server does not send unnecessarily detailed content to constrained devices.

In yet another embodiment, the server aggregates multiple information items on the same topic and generates a composite summary. The server merges text data from several sources, annotates each sentence with a source identifier, and then generates a prompt sentence instructing the generative AI model to identify overlapping and conflicting information. The server, for instance, generates a prompt sentence such as: “Summarize the following multiple news articles on the same topic in bullet points. Merge duplicate information, highlight differences among sources, and focus on facts that are confirmed by more than one source: [combined article bodies].”

The server then constructs a summary display data structure that includes, for each bullet-point element, a list of contributing sources. By doing so, the server enables the user to view a consolidated, redundancy-reduced summary that leverages the model's ability to integrate multiple inputs, which would be technically difficult and time-consuming for a human to replicate manually.

The system as a whole thus implements a specialized configuration of server-side processing and terminal rendering that yields a concrete improvement in computer operation. The server reduces the number of network round trips by coordinating retrieval, translation, generative inference, and layout computation in a single integrated workflow. The server reduces computational redundancy by reusing intermediate results and by dynamically adjusting prompt sentences instead of re-running the entire pipeline from scratch. The terminal reduces local processing by consuming a normalized summary display data structure. Through these interactions, the system improves processing speed, reduces memory usage, lowers communication bandwidth, and enhances the accuracy and structural consistency of generated bullet-point summaries in a manner tied to the particular architecture and algorithms of the underlying computing devices.

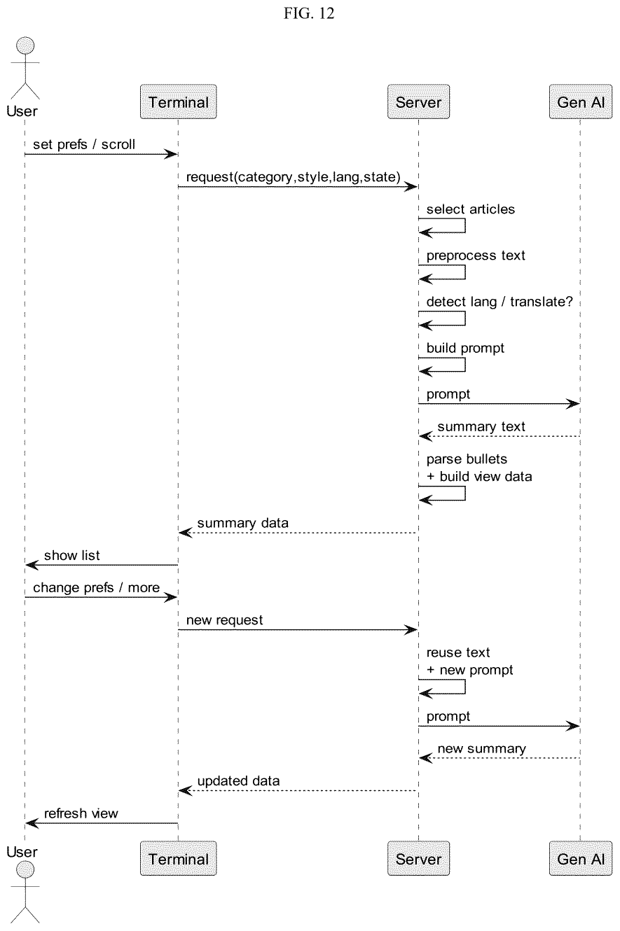

The following describes the processing flow using FIG. 12.

### Step 1:

The terminal initializes an application and loads stored user preferences (input) from a local storage area into memory.

The terminal reads parameters such as preferred article categories, default summarization style, display language, and previously stored comprehension level, and constructs an initial preference object (output) that will be sent to the server.

### Step 2:

The user operates the terminal to confirm or modify the preference object (input) via a graphical user interface.

The user selects at least one article category, a summarization style, and optionally adjusts the comprehension level and language, and the terminal updates the preference object accordingly and prepares request information (output) that encapsulates these values together with browsing status.

### Step 3:

The terminal transmits the request information (input) to the server over a network using a request message formatted in a structured data format.

The terminal sends fields such as user identifier, article category, summarization style, display language, comprehension level, and current scroll position, and outputs a network packet (output) addressed to the server's network interface.

### Step 4:

The server receives the network packet (input) via the network interface and decodes the structured request information.

The server parses the request to extract individual parameters, logs the request metadata for monitoring, and generates an internal request context object (output) that will be used across subsequent processing steps.

### Step 5:

The server uses the request context object (input) to query an information source storing information items.

The server executes a retrieval operation based on article category, publication time, language, and optionally relevance scores, and produces a list of candidate information items (output) including text data, attribute information, and media identifiers.

### Step 6:

The server takes the list of candidate information items (input) and performs ranking and selection.

The server computes a relevance score for each item based on attribute information and user preference history, sorts the items by score, and outputs a subset of high-ranked information items (output) as summarization targets.

### Step 7:

The server extracts text data and media data (input) from each selected information item.

The server reads article titles, bodies, and associated media identifiers from storage, and constructs an in-memory article object (output) that groups text data, attribute information, and media data for each summarization target.

### Step 8:

The server applies preprocessing to the article object (input) to normalize and clean text data.

The server removes markup, scripts, advertisements, and boilerplate using pattern matching, performs tokenization and sentence segmentation using a natural language processing library, and produces preprocessed text data (output) suitable for further language analysis.

### Step 9:

The server performs language determination on the preprocessed text data (input).

The server either reads a stored language code from attribute information or applies a language detection algorithm that computes likelihoods for each candidate language, and outputs a confirmed language identifier (output) for the article.

### Step 10:

The server compares the confirmed language identifier and the display language in the request context (input) to decide whether translation is needed.

When the languages differ, the server sends the preprocessed text data to a translation engine and receives translated text, and outputs either original or translated text data (output) as effective text data for summarization.

### Step 11:

The server uses the effective text data and the request context (input) to construct a prompt sentence for a generative AI model.

The server selects a prompt template based on article category, summarization style, and comprehension level, substitutes textual parameters, and concatenates the instruction part with the effective text data, thereby generating a prompt sentence (output) that encodes both instructions and content.

### Step 12:

The server encodes the prompt sentence (input) into token identifiers using a tokenizer compatible with the generative AI model.

The server maps characters or subword units to numerical token IDs, segments the prompt into a token sequence within allowed length, and produces a tokenized input (output) for the generative AI model.

### Step 13:

The server inputs the tokenized prompt (input) into the generative AI model implemented as a neural network.

The server executes inference on specialized hardware, propagating the token embeddings through attention layers and feed-forward layers, and acquires a sequence of output token identifiers (output) that represent a generated summary.

### Step 14:

The server decodes the output token identifiers (input) back into text.

The server applies a vocabulary mapping from token IDs to text fragments, concatenates these fragments into a summary text string, and outputs the generated summary text (output) containing multiple lines that are expected to correspond to bullet points.

### Step 15:

The server analyzes the generated summary text (input) to identify and separate bullet-point elements.

The server scans each line for bullet markers or delimiters, splits the text on these delimiters, trims whitespace, filters out empty lines, and outputs an ordered list of bullet-point elements (output).

### Step 16:

The server processes the list of bullet-point elements (input) to enforce constraints and unify expressions.

The server calculates the number of bullet points, truncates the list to a configured maximum, normalizes capitalization and punctuation, optionally runs a grammar checker, and produces a refined list of bullet-point elements (output) with consistent style.

### Step 17:

The server associates the refined bullet-point elements with media data (input) for each article.

The server links each bullet-point list to corresponding images and videos using media identifiers from the article object, resolves those identifiers to resource locations, and generates a summary display data structure (output) that includes bullet texts, media references, and layout attributes.

### Step 18:

The server determines whether the summary display data structure (input) needs translation to match the display language.

If required, the server sends the bullet-point texts to the translation engine, receives translated bullet-point elements, replaces or supplements the original texts, and outputs an updated summary display data structure (output) in the target language.

### Step 19:

The server packages the summary display data structure (input) into a response message.

The server organizes the data into a format suitable for transmission, attaches metadata such as article identifiers and timestamps, and outputs a serialized response (output) that can be sent through the network.

### Step 20:

The server transmits the serialized response (input) to the terminal over the network.

The server writes the response into a network socket associated with the terminal connection, applies compression or encryption as configured, and outputs network packets (output) carrying the summary display data structure.

### Step 21:

The terminal receives the network packets (input) and reconstructs the response message.

The terminal decodes the serialized response into an internal data structure, extracts the summary display data structure, and outputs a local summary data object (output) stored in memory.

### Step 22:

The terminal uses the local summary data object (input) to render a continuous vertical list on the display.

The terminal maps each bullet-point element and associated media reference to visual components, lays them out in a vertically scrollable arrangement, and outputs rendered content (output) visible to the user on the screen.

### Step 23:

The user interacts with the rendered content (input) by scrolling and selecting elements.

The user changes the scroll position to browse additional summaries or taps a summary item to request more details, and the terminal records updated browsing status and user selections (output).

### Step 24:

The terminal evaluates the updated browsing status and user selections (input) to decide whether to request additional summaries or re-summarization.

When the user approaches the end of the current list or adjusts preferences such as article category, summarization style, or comprehension level, the terminal constructs new request information with updated parameters and browsing status (output) for transmission.

### Step 25:

The server receives the new request information (input) and updates user preference information.

The server stores new category choices, style settings, and comprehension level in a user profile, reuses previously retrieved text data where applicable, and outputs an updated request context (output) that reflects both prior and new inputs.

### Step 26:

The server regenerates a prompt sentence (input) based on the updated request context and previously stored effective text data.

The server modifies template parameters such that the prompt sentence now reflects new style or comprehension constraints, for example instructing a more casual or more detailed explanation, and outputs a revised prompt sentence (output) for re-summarization.

### Step 27:

The server repeats summarization, post-processing, and summary display data structure construction using the revised prompt sentence (input) and existing article objects.

The server runs the generative AI model again with modified instructions, recalculates bullet-point elements, updates associated media references, and generates an updated summary display data structure (output) that matches the new user preferences.

### Step 28:

The terminal receives the updated summary display data structure (input) and refreshes the rendered list.

The terminal replaces or augments existing visual components with newly generated bullet-point elements, maintains scroll continuity where applicable, and outputs an updated display (output) showing summaries that reflect the user's latest interactive inputs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval and summarization systems primarily focus on delivering search results or static summaries without significantly improving the underlying operation of computer systems that process large-scale, heterogeneous information. Such systems typically perform simple keyword searches and fixed summarization workflows, which (i) do not adapt the computation to evolving user intent expressed through dialog-type interactions, (ii) do not systematically integrate multilingual processing and translation into a single, optimized summarization pipeline, and (iii) do not exploit processing history and performance feedback to improve subsequent processing steps. As a result, existing systems often cause inefficient use of processing resources, such as repeated data acquisition and redundant natural language processing, increased latency in response to user interactions, and non-optimal control of generative artificial intelligence models.

In typical architectures, once a summary is generated for a given query, later refinements from the user are handled either by re-running the entire pipeline from scratch or by performing ad hoc text transformations on the final summary, without reusing structured intermediate data or updating system control parameters. This limits the system's ability to reuse previously acquired source data or prior summaries, increases network and processor load, and fails to leverage the conversational history in a structured manner. Additionally, conventional systems often treat translation as an independent post-processing step that is not integrated into the summarization control logic, which leads to duplicated processing, inconsistent language handling across requests, and unnecessary invocation of translation and summarization components.

Furthermore, the control of generative artificial intelligence models in conventional systems is typically static, with fixed prompt patterns and model parameters that do not change based on observed behavior, summary quality, or performance metrics. This prevents the system from optimizing the usage of computational resources such as processor cycles, memory, and external model-inference services. It also limits the ability to dynamically tailor the summarization behavior (for example, length, level of detail, domain focus, or expression level) to the evolving needs and comprehension levels of different users in a dialog context.

Accordingly, there is a need for a computer-implemented system that improves the operation of information processing devices by: (i) integrating acquisition, preprocessing, summarization, translation, and formatting into a unified, controllable pipeline driven by prompt sentences and dialog-type interactions; (ii) reusing original data and existing summaries based on identification information to avoid redundant processing and reduce latency; and (iii) recording processing history and performance information to adapt control parameters for subsequent prompt generation and summarization in a way that systematically optimizes computational behavior. Such improvements are desired not merely to automate a human mental process, but to enhance how the computer system manages and allocates processing resources, controls generative artificial intelligence models, and provides scalable, responsive summarization functionality in multi-lingual and interactive environments.

The specific processing by the specific processing unit 290 of the data processing device 12 in Example 2 is realized by the following means.

The present invention provides a server comprising a processor configured to acquire information from one or more information sources, convert the acquired information into text data, and perform preprocessing on the text data; generate, on the basis of the preprocessed text data and a prompt sentence received from a user terminal, a prompt to instruct a generative artificial intelligence model to analyze and summarize the information, and input the prompt into the generative artificial intelligence model; format summary information output from the generative artificial intelligence model into a predetermined display format including a format that allows continuous vertical display, and transmit the formatted summary information to the user terminal; perform, on the basis of an additional prompt sentence or operation instruction input in a dialog form from the user terminal, iterative adjustment of the summary information by instructing the generative artificial intelligence model again to change at least one of length, level of detail, target domain, or expression level of the summary information; determine a language of the summary information and, when the language is different from a target language specified by a user, translate the summary information into the target language by using machine translation processing; generate new summary information corresponding to the dialog-type prompt sentence by reusing, on the basis of identification information received from the user terminal, at least one of original data acquired from the information source and existing summary information; and record processing history and performance information relating to the acquiring, preprocessing, summarizing, translating, and formatting, and update control parameters for subsequent prompt generation and summarization processing. This enables an improvement in computer functionality by implementing an integrated, feedback-driven processing pipeline that reduces redundant data acquisition and language processing, adaptively controls a generative artificial intelligence model based on dialog-type user interactions and recorded performance metrics, and optimizes resource usage and response latency while providing dynamically refined, multi-lingual summaries tailored to user-specific requirements.

The term “system” refers to a combination of one or more hardware devices and software modules that cooperate to execute information processing operations described in the claims.

The term “server” refers to an information processing apparatus including at least one processor, memory, and communication interface, configured to provide processing services to one or more user terminals over a communication network.

The term “processor” refers to a hardware computation unit, such as a central processing unit or a processing core, capable of executing machine-readable instructions to perform logical operations, arithmetic operations, data movement, and control of peripheral components.

The term “information source” refers to any data repository or service, including network-accessible services, databases, file systems, or application interfaces, from which information can be obtained for subsequent processing.

The term “information” refers to data items, such as documents, records, messages, or content objects, that include textual content and optionally other media content, which are acquired from an information source.

The term “text data” refers to data represented in a character-based format, such as encoded strings, sentences, or paragraphs, suitable for processing by natural language processing algorithms.

The term “preprocessing” refers to a series of operations applied to acquired text data before summarization, including at least one of normalization, cleaning, tokenization, segmentation, language detection, format conversion, or removal of non-relevant elements.

The term “prompt sentence” refers to a text string supplied by a user or a user terminal, expressing a request, instruction, or question, which is used as input for controlling how a generative artificial intelligence model processes information.

The term “prompt” refers to a data structure including at least one instruction, condition, or context representation, constructed on the basis of preprocessed text data and a prompt sentence, and provided as input to a generative artificial intelligence model to control its behavior.

The term “generative artificial intelligence model” refers to a machine learning model, such as a neural network model, configured to generate output data including natural language text by processing input data and prompts, and capable of performing tasks such as summarization, translation, or rephrasing.

The term “analyze” refers to processing operations by which a generative artificial intelligence model or other algorithm identifies structure, meaning, topics, or relationships in input data, such as extracting key points, concepts, or entities.

The term “summarize” refers to generating condensed output information that preserves main points or essential content of original information while reducing length or complexity.

The term “summary information” refers to data representing a result of a summarization operation, including at least an abbreviated textual representation of the original information, and optionally additional metadata such as headings, bullet points, or section structures.

The term “display format” refers to a layout specification or structural representation indicating how summary information is to be arranged for visual presentation on a display device, including elements such as sections, lists, headings, or visual ordering.

The term “continuous vertical display” refers to a presentation mode in which content is displayed in a vertically arranged region that can be scrolled or navigated in an up-and-down direction without discrete page boundaries.

The term “user terminal” refers to any client device operated by a user, such as a mobile device, a tablet device, a personal computer, or another computing device, that can transmit prompt sentences and receive summary information via a communication network.

The term “dialog form” refers to an interaction mode in which multiple exchanges of messages occur between a user terminal and a server, such that user instructions and system responses are iteratively exchanged to refine processing results.

The term “operation instruction” refers to a command or setting change, provided by a user through a user terminal, that specifies modification of one or more processing parameters, such as summary length or level of detail.

The term “iterative adjustment” refers to a processing sequence in which summary information is repeatedly modified or regenerated multiple times based on successive prompt sentences, operation instructions, or updated control parameters.

The term “length of the summary information” refers to a measure of the amount of content in a summary, such as number of words, number of sentences, or approximate reading size, controllable as a parameter.

The term “level of detail” refers to a granularity of information expressed in a summary, indicating how many specific facts, explanations, or examples are included.

The term “target domain” refers to a particular subject area, category, or field of interest, such as a technical field or application area, on which a summary is instructed to focus.

The term “expression level” refers to a style or complexity of wording used in a summary, including at least difficulty level, formality, or tone, which may be adapted to different comprehension levels or user attributes.

The term “language of the summary information” refers to a natural language, such as English or Japanese, in which the text of the summary information is expressed.

The term “target language” refers to a natural language designated by a user or a system setting as a desired output language for summary information after translation.

The term “machine translation processing” refers to automatic conversion of text from one natural language to another natural language by a computational method such as a rule-based, statistical, or neural network-based translation algorithm.

The term “identification information” refers to data that uniquely or semi-uniquely associates a processing request, a user session, original data, or existing summary information with a particular context, enabling retrieval or reuse of related data.

The term “original data” refers to data acquired from an information source before summarization, including raw documents or unprocessed content.

The term “existing summary information” refers to summary information that has been previously generated and stored for a past request or processing context.

The term “processing history” refers to recorded information about past executions of acquiring, preprocessing, summarizing, translating, formatting, or related operations, including input parameters, outputs, and execution times.

The term “performance information” refers to metrics or measurements relating to behavior of the system, including processing time, resource consumption, error occurrences, or quality indicators of generated summaries.

The term “control parameters” refers to adjustable values or settings used by the server to influence behavior of prompt generation, generative artificial intelligence model invocation, or other processing, including parameters such as model selection, temperature, token limits, or preferred output structure.

The term “bullet-point format” refers to a textual representation in which key points are listed as discrete items, each associated with a marker or indentation, such as a list of short sentences or phrases.

The term “structured format with headings” refers to a textual representation in which content is organized under explicit section labels or headings, thereby dividing the summary into multiple named segments.

The term “user input” refers to data or signals provided by a user through a user terminal, including prompt sentences, selection of options, or adjustments of interface controls.

The term “comprehension level” refers to a degree of assumed knowledge or expertise of a target reader, such as beginner level, intermediate level, or expert level, which influences the way content is expressed.

The term “user attributes” refers to properties or characteristics associated with a user, such as age group, profession, field of interest, or preference profile, which may be used to customize summary expression.

The term “usage purposes” refers to intended application scenarios for the summary information, such as education, business decision-making, technical review, or general overview, that influence the style and content of the summary.

The term “template” refers to a predefined pattern or rule set for structuring and styling output text, which, when applied to a result produced by a generative artificial intelligence model, controls aspects such as section ordering, heading names, and phrase style.

In an embodiment, a server cooperates with one or more terminals to implement the claimed system. The server includes at least one processor, a main memory, a non-transitory storage device, and a network interface. The server executes an operating system such as a general-purpose server operating system, and one or more application programs implementing an information acquisition module, a text preprocessing module, a prompt generation module, a generative AI model inference module, a translation module, a formatting module, and a history/parameter control module. The terminal includes a processor, a display, an input interface such as a touch panel, and a communication interface, and executes a client application or web browser that provides a user interface for transmitting a prompt sentence and for receiving and displaying summary information.

In an embodiment, the server uses general-purpose hardware, such as an x86_64 central processing unit and a graphics processing unit (for example, a GPU compatible with a parallel-computing architecture like CUDA), a main memory having a capacity sufficient to store tokenized text sequences, and a solid-state storage device for storing log data, model parameters, and intermediate representations. The server executes software components such as a web application framework (for example, a server-side framework providing HTTP/HTTPS endpoints), a natural language processing library, a machine translation engine, and a model-serving framework for a generative AI model. The generative AI model conforms to a transformer-based neural network architecture including an embedding layer, a plurality of self-attention layers, feedforward layers, and output projection layers.

In an embodiment, the server implements the generative AI model as a multi-layer transformer network with, for example, 12 to 48 layers, each layer including multi-head scaled dot-product attention and position-wise feedforward networks. The server stores model parameters, including weight matrices for query, key, and value projections, feedforward weights, layer normalization parameters, and output projection weights, as floating-point tensors in non-transitory storage. The server loads these tensors into main memory and GPU memory at runtime. The server configures the model with a predefined vocabulary and corresponding token embeddings. The server determines attention weights through matrix multiplications and softmax operations and generates output tokens autoregressively based on conditional probability distributions. The server updates the model parameters during an offline training phase using a gradient-based optimization algorithm such as stochastic gradient descent or Adam, minimizing a loss function such as cross-entropy between predicted tokens and target tokens. The server may perform data augmentation during training, such as random masking of tokens, sentence permutation within documents, or injection of noise in order to increase robustness and improve the quality of downstream summarization.

In an embodiment, the server uses specific data structures to implement the processing pipeline. The server represents each acquired document as a document record including fields such as a document identifier, a source identifier, a language code, a raw content field, a normalized text field, and metadata fields such as timestamp and topic tags.

The server stores document records in a database management system. The server represents each prompt sentence from a user as a prompt record including a prompt identifier, a user identifier, a text field for the prompt sentence, preference parameters such as target language and desired length, and a reference to one or more associated document identifiers. The server represents each generated summary as a summary record including a summary identifier, an associated prompt identifier, a text field for the summary information, a structure field describing headings and bullet-point segments, and performance fields describing generation time, number of tokens, and translation status.

In an embodiment, the server performs text preprocessing using explicit algorithms. The server uses a tokenizer to segment text into tokens based on a predefined subword vocabulary, such as byte-pair encodings or sentence-piece units. The server performs normalization such as lowercasing, Unicode normalization, and removal of control characters. The server uses a language detection algorithm that computes language probabilities from character n-gram statistics or uses a small classifier neural network trained to classify text segments into language codes. The server removes HTML tags and boilerplate by parsing documents using an HTML parser and applying rule-based filters that discard elements based on tag type, CSS class patterns, or position in the document tree. This explicit preprocessing reduces the input sequence length and noise, which in turn improves both the computational efficiency of the generative AI model and the accuracy of key point extraction.

In an embodiment, the server generates prompts for the generative AI model according to non-conventional rules that improve computational behavior and summarization quality. The server does not simply forward the user's prompt sentence verbatim; instead, the server composes a structured prompt including a system-level instruction, an explicit task description, constraints on length and style, and a serialized representation of the input documents. The server organizes input content as a sequence of labeled sections, such as “Source 1: [text]”, “Source 2: [text]”, and so on, and uses markup tokens or tags to delimit sections. The server includes meta-instructions such as “Summarize key points across all sources and remove redundant information” or “Produce bullet-point items grouped by topic,” which are not mere restatements of user instructions but control tokens that guide the model to perform de-duplication and topic clustering. The server thus uses the prompt as a machine-control structure that configures the generative AI model's internal attention patterns and generation strategy, improving both efficiency and determinism.

In an embodiment, the server uses iterative adjustment of the summary information based on dialog-type user interactions, and this adjustment is implemented as a technical feedback loop controlling the generative AI model and the data selection algorithms. The server maintains a conversation state data structure that associates multiple prompt records and summary records with a conversation identifier. The server computes features from the conversation state, such as how much the user has shortened or lengthened summaries in previous rounds, which domains the user has selected, and which sections have been expanded or discarded. The server then updates control parameters for subsequent summarization, such as maximum output token length, the weighting of different document sections in the prompt, and the temperature and top-k/top-p parameters used in sampling. These control parameters directly influence how the generative AI model's sampling algorithm selects output tokens, thereby reducing variance and enforcing consistency with the user's expressed preferences. Because the server uses this historical state to alter token-level generation parameters, the system achieves improved latency and stability compared to simply regenerating summaries without such adaptation.

In an embodiment, the server integrates translation as part of the controlled pipeline, rather than as a simple add-on. The server computes a language code for each piece of summary information and compares it with a target language parameter retrieved from the prompt record. The server then selects between two strategies: instructing the generative AI model to output directly in the target language by adding a language constraint to the prompt, or generating the summary in a source language and then invoking a dedicated machine translation engine. The server may choose the strategy based on performance information, such as which method produced fewer errors or shorter latency in past sessions. The server stores translation metrics such as character-level edit distance between back-translated text and the original, allowing the history/parameter control module to adaptively route requests. By integrating translation decisions with summarization control, the server reduces redundant translation calls and avoids double translation, which directly improves processing throughput and decreases network usage.

In an embodiment, the terminal provides a user interface that is optimized for continuous vertical display of summary information. The terminal displays headings, bullet points, and paragraph segments in a scrollable layout, and renders content using the display hardware and graphics library. The terminal sends not only the prompt sentence but also layout capability information, such as available screen height, font scale, or orientation, as part of the prompt record. The server uses this information when formatting summary information, for example by limiting paragraph length, inserting explicit section breaks, and choosing between bullet-point and paragraph styles. As a result, the user does not need to manually reorganize information to fit the device; instead, the server pre-computes a layout-friendly structure, which reduces the number of screen redraws and layout recalculations on the terminal.

In an embodiment, the server improves computational efficiency and reduces communication load by reusing original data and existing summary information based on identification information. The server uses a hash of normalized document content or a canonicalized URL as a document identifier. When a new prompt sentence relates to a previously processed topic, the server retrieves the corresponding document records and summary records, rather than acquiring the same documents again from the information source. The server may partially reuse previous summaries by performing a second-stage summarization in which the generative AI model receives a compact representation of earlier summaries as input. This hierarchical summarization significantly reduces input token counts and thus GPU computation time, while preserving key information. The server also caches tokenized representations and embedding vectors of frequently used documents, so that repeated summarization tasks do not require re-tokenization or re-embedding. This reuse leads to lower latency and less network traffic, and these improvements are tied to specific data structures and control logic rather than merely automating human reading.

In an embodiment, the server uses rule-based and learned mechanisms that differ from human manual summarization. For example, the server assigns weights to different sections of documents based on factors such as term frequency-inverse document frequency, recency, and structural position (e.g., whether a sentence is in a title, lead paragraph, or conclusion). The server encodes these weights as numerical features that are inserted into the prompt in a structured form, such as special tokens indicating high-importance passages. The generative AI model is fine-tuned with data where such tokens correlate with inclusion in summaries, thereby enforcing machine-specific selection rules that human readers would not explicitly apply. Additionally, the server can enforce non-conventional constraints, such as limiting duplication across sources by penalizing generation of n-grams that have already appeared in previous summaries, implemented via a repetition penalty applied at the token probability level.

In an embodiment, the server records processing history and performance information in an analytics store. The server logs, for each summarization or translation operation, the number of tokens processed, the time consumed by each module (preprocessing, model inference, translation, formatting), error codes, and outcome indicators such as user satisfaction ratings or correction requests. The server computes aggregated statistics from these logs, such as average latency per model configuration, failure rates for particular parameter combinations, and token usage over time. The history/parameter control module periodically updates configuration tables used by the runtime system, which specify, for example, preferred model sizes for different prompt lengths, thresholds for switching to hierarchical summarization, and default language-handling strategies. By automatically adjusting these configuration tables based on measured performance, the server implements a technical feedback loop that optimizes resource allocation and computation paths in a way not achievable by static configuration or human tuning alone.

In an embodiment, the user interacts with the system using natural-language prompt sentences such as “Tell me about the latest AI technologies,” “Summarize the latest technology news,” “Summarize the latest technology news in a way that a high school student can understand,” “Translate and summarize recent AI ethics articles from English into Japanese,” “Give me a brief, bullet-point overview of current trends in autonomous vehicles,” or “Summarize recent healthcare applications of generative AI, and focus on clinical use cases.” The terminal transmits these prompt sentences to the server, and the server generates corresponding prompt structures for the generative AI model as described above. When the user provides a follow-up instruction such as “Make this summary shorter and focus only on real-world applications” or “Add a section on privacy concerns,” the server retrieves the conversation state and existing summary records, and then constructs a refinement prompt that explicitly references specific sections for expansion, contraction, or filtering. By manipulating references to internal text segments and maintaining conversation-aware context, the server avoids recomputing initial summaries and instead performs delta-style updates, which reduces computational demand and network usage.

In an embodiment, alternative configurations are possible. The server may execute the generative AI model locally on a GPU-equipped machine, or access a remote model-inference service via a secured application programming interface. The server may employ different neural network architectures, such as encoder-only or encoder-decoder transformers, provided that the architecture can process concatenated document sequences and instruction tokens. The server may use different optimization algorithms, loss functions, or pretraining corpora, while still operating within the claimed framework of using preprocessed text data and prompt sentences to control summarization, translation, and formatting in a unified pipeline. The server may also support multiple user terminals concurrently, using request queues and load-balancing strategies to allocate processor and GPU resources.

In an embodiment, the described structure and operations provide technical effects beyond mere automation of human reading and summarization. The server reduces redundant data acquisition and processing by recognizing repeated content and reusing document and summary records. The server improves processing speed by using token-level caching, hierarchical summarization, and adaptive model parameter selection based on historical performance. The server reduces communication load by transmitting compact, structured summary representations instead of raw documents, and by allowing terminals to request only incremental changes based on identification information. The server increases accuracy and consistency by integrating language detection and translation control into the summarization pipeline, and by using explicit control tokens and templates to stabilize generative AI behavior. These improvements are realized through specific data structures, algorithms, and control flows implemented in the server and are not merely high-level business or presentation logic.

In an embodiment, the terminal can also be configured to provide local preprocessing or post-processing to further offload tasks from the server. For example, the terminal may locally adjust font size or presentation style without changing the underlying summarization, or may perform client-side caching of recent summaries to reduce bandwidth usage. However, the core operations of acquiring, preprocessing, generating prompts, invoking the generative AI model, translating, formatting according to vertical display constraints, and updating control parameters based on processing history are centrally performed by the server, which is specifically configured to improve computational behavior and system performance in interactive, multi-lingual summarization scenarios.

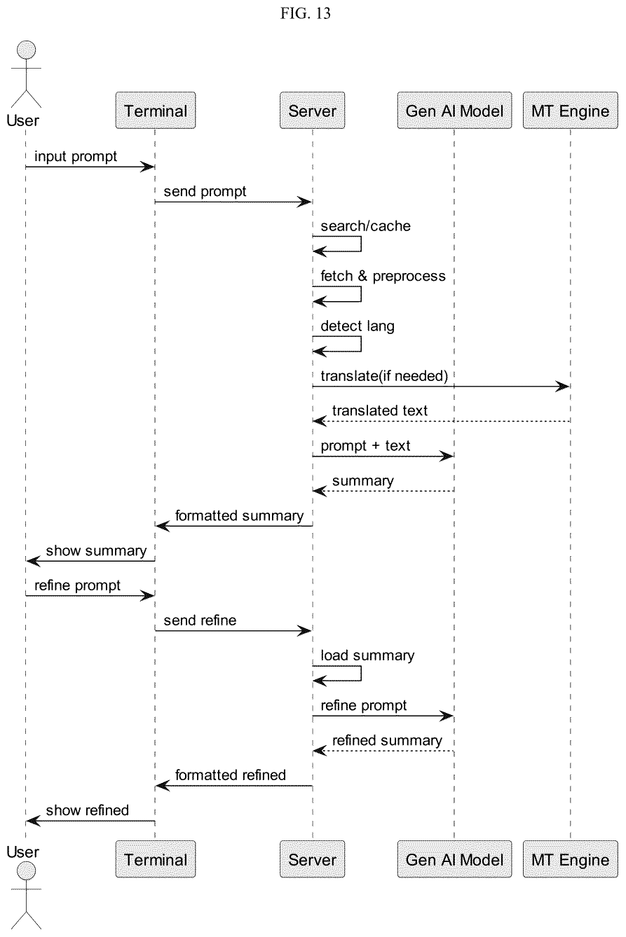

The following describes the processing flow using FIG. 13.

### Step 1:

The user operates the terminal to launch a client application and view an input screen including a text input field and a send control. The input of this step is an empty prompt field and an initial user interface state. The user enters a prompt sentence such as “Tell me about the latest AI technologies” or “Summarize the latest technology news in a way that a high school student can understand” using a keyboard or touch panel, and then activates the send control. The output of this step is a prompt sentence stored in the terminal's memory together with user preference settings such as target language and desired summary length.

### Step 2:

The terminal packages the prompt sentence and associated user preferences into a request message, for example a structured object containing fields for user identifier, prompt text, and display constraints. The input of this step is the prompt sentence and current preference settings. The terminal performs data formatting operations such as string encoding, JSON serialization, and header attachment to create an HTTP or HTTPS request. The output of this step is a network-transmittable request that is sent through the terminal's communication interface to the server.

### Step 3:

The server receives the request through a network interface and passes it to a request handling module. The input of this step is the serialized request message from the terminal. The server decodes the request, verifies message integrity, parses the prompt sentence, and extracts preference parameters such as target language, summary length, and domain focus. The server also logs the request metadata to persistent storage. The output of this step is an internal request representation containing the prompt sentence, user preferences, and a generated request identifier.

### Step 4:

The server determines whether relevant original data already exists in storage by using the internal request representation. The input of this step is the parsed prompt sentence and any associated identification information such as topic tags or conversation identifiers. The server computes one or more search keys, for example by hashing normalized prompt text or deriving topic keywords, and queries a document store and summary store. The server performs lookup operations to decide whether reusable document records or summary records exist. The output of this step is either a set of retrieved records that match the request or an indication that new acquisition from external information sources is required.

### Step 5:

The server acquires information from one or more information sources when reusable data is insufficient. The input of this step is a set of keywords and conditions derived from the prompt sentence, such as “latest,” “AI,” and “technologies,” and any time-range constraints. The server issues network requests to information sources, receives raw data such as HTML pages or structured feeds, and stores the raw content in document records. The server performs data acquisition operations including HTTP retrieval, response decoding, and primary filtering based on content-type and basic length checks. The output of this step is a collection of raw documents stored in the document store and linked to the current request identifier.

### Step 6:

The server performs text preprocessing on the acquired raw documents. The input of this step is the collection of raw document records, each containing raw content and metadata. The server executes parsing, normalization, and tokenization processes: stripping markup, removing boilerplate regions, normalizing character encodings, segmenting text into sentences, and converting sentences into tokens using a tokenizer compatible with the generative AI model. The server computes language codes for each document using a language detection algorithm and stores the normalized text and language codes back into the document records. The output of this step is a set of preprocessed document records containing normalized text fields and language annotations suitable for downstream processing.

### Step 7:

The server performs translation on the preprocessed text when the document language differs from the user's target language. The input of this step is the set of preprocessed document records and the target language parameter. The server identifies documents with language codes not matching the target language, sends their text segments to a machine translation engine, and receives translated text segments. The server replaces or augments the normalized text fields with translated versions and updates translation status flags in each record. The output of this step is a unified set of document records whose normalized text is expressed in the target language or in a language chosen for summarization.

### Step 8:

The server constructs an input sequence for the generative AI model from the translated and preprocessed documents. The input of this step is the set of language-harmonized document records and the original prompt sentence. The server orders documents based on relevance metrics such as recency, keyword match score, or source reliability, and then concatenates or segments the texts into chunks that do not exceed model token limits. The server inserts control tokens and section markers to delimit different sources and to label high-importance segments. The output of this step is a structured text sequence or set of sequences that represent the combined information to be summarized.

### Step 9:

The server generates a model control prompt based on the structured input sequence and the user's intent. The input of this step is the structured document sequence and the prompt sentence with user preferences. The server composes a prompt including system-level instructions such as “You are a summarization assistant,” explicit task statements like “Summarize the following information about the latest AI technologies,” and constraints such as desired length, bullet-point usage, and comprehension level. The server embeds tokens that instruct the model to group content by topic or domain and to avoid redundancy. The output of this step is a model-ready prompt that includes both instruction text and serialized content segments.

### Step 10:

The server performs inference of the generative AI model using the constructed prompt. The input of this step is the model-ready prompt with text and control tokens. The server encodes tokens into numerical embeddings, processes them through the transformer-based model layers, and computes attention scores and intermediate activations using matrix multiplications and non-linear functions. The server generates output tokens autoregressively by repeatedly computing probability distributions over the vocabulary and applying sampling or decoding algorithms configured by control parameters such as temperature and top-k. The output of this step is a sequence of generated tokens that represent the summarized information.

### Step 11:

The server post-processes the generated token sequence to create summary information. The input of this step is the raw generated token sequence. The server decodes tokens into text strings, removes undesired repetition or incomplete segments, and segments the text into logical units such as headings, bullet points, and paragraphs. The server may detect phrases indicating topic boundaries and insert section labels accordingly. The server constructs a summary record with fields for summary text, structural markup, and generation metadata such as token count and processing time. The output of this step is formatted summary information stored in association with the prompt identifier.

### Step 12:

The server formats the summary information for vertical display on the terminal. The input of this step is the summary record and information about the terminal's display capabilities, such as screen size or font scaling preferences. The server applies layout rules to segment the summary into display blocks, assigns heading levels, and decides which portions are presented as bullet lists versus paragraphs. The server may truncate or expand certain sections to conform to display constraints and user-specified length. The output of this step is a response payload containing text segments, structural annotations, and optional visual elements arranged for continuous vertical display.

### Step 13:

The server transmits the formatted summary information to the terminal. The input of this step is the response payload generated in the previous step. The server serializes the payload into a transmission format, attaches status codes and headers, and sends the response via the network interface using a reliable transport protocol. The server logs the response size, processing duration, and any error conditions in a history store. The output of this step is a network message delivered to the terminal containing the structured summary.

### Step 14:

The terminal receives the summary response and updates the user interface. The input of this step is the transmitted response payload. The terminal decodes the serialized data, parses the structural annotations, and generates display objects such as heading elements, list items, and text blocks. The terminal arranges these display objects in a vertically scrollable region, configures scroll behavior, and renders the content on the display. The output of this step is a visible summary presented to the user, with the prompt sentence optionally shown at the top for context.

### Step 15:

The user reads the summary and decides whether refinement is necessary. The input of this step is the displayed summary information and the user's understanding state. The user examines headings, bullet points, and detail levels and may identify needs such as “shorter summary,” “focus on healthcare applications,” or “add privacy concerns section.” The user then enters a follow-up prompt sentence such as “Make this summary shorter and focus only on real-world applications” or “Add a section on privacy concerns” using the terminal input interface. The output of this step is a refinement prompt that expresses user instructions for adjusting the existing summary.

### Step 16:

The terminal packages the refinement prompt together with identification information relating to the existing summary. The input of this step is the refinement prompt and identifiers such as summary identifier or conversation identifier. The terminal constructs a new request message that includes the refinement instructions, the identifiers of the summaries to be adjusted, and any updated preference parameters. The terminal serializes and transmits this request to the server using the same communication mechanism as in the initial request. The output of this step is a refinement request that links the new instructions with existing data.

### Step 17:

The server interprets the refinement request and prepares new input for the generative AI model. The input of this step is the refinement request containing the refinement prompt and summary identifiers. The server retrieves the corresponding summary records and any associated document records from storage. The server analyzes the refinement prompt to identify changes in length, domain focus, or expression level. The server then composes a new model control prompt that includes the existing summary as context, explicit instructions for modification, and any additional constraints derived from user preferences or system policies. The output of this step is a refined model-ready prompt that references prior summaries and directs the generative AI model to adjust them.

### Step 18:

The server performs a secondary summarization or transformation using the generative AI model based on the refinement prompt. The input of this step is the refined model-ready prompt containing existing summary text and updated instructions. The server processes this input through the generative AI model, as in the primary summarization, to generate a modified token sequence that reflects the requested shortening, focusing, or rephrasing. The server decodes and structures this sequence into a new summary record, linking it to the same conversation identifier and logging updated performance metrics such as token reduction ratio and latency improvement. The output of this step is a refined summary that responds specifically to the user's dialog-based instructions.

### Step 19:

The server formats and returns the refined summary to the terminal. The input of this step is the refined summary record and the terminal's display context. The server applies the same vertical-display formatting rules, possibly highlighting differences from the original summary or labeling the summary as an updated version. The server transmits the formatted refined summary as a response payload. The terminal then receives this payload, inserts or replaces the corresponding displayed content, and allows the user to scroll through and compare the original and refined summaries. The output of this step is an updated display state on the terminal that presents the refined summary and supports further iterative interaction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that perform text summarization using machine learning models typically execute a fixed summarization pipeline: raw content is fetched from a source, optionally cleaned, and provided to a model that generates a static summary. Such systems exhibit several technical limitations from the standpoint of computer technology.

First, summary generation logic is often hard-coded on the server side, and the model input is not flexibly parameterized. The server usually submits only the raw text and a generic instruction to a summarization model. As a result, the server cannot systematically encode dynamic constraints (such as user understanding level, desired tone, emotional state, or output language) into the model input. This leads to repeated and inefficient server-side post-processing, including multiple regeneration cycles or heuristic re-writing, which increases processor load, network traffic, and latency.

Second, conventional systems generally treat user feedback and interaction as a separate, high-level UI concern, rather than as structured control signals for the core summarization pipeline. In typical architectures, when a user requests a different style or level of detail, the system either returns pre-canned variants or re-runs the same model with only coarse configuration changes. The server does not maintain a unified representation of “prompt sentences” as machine-generated control instructions, nor does it maintain a systematic mechanism for regenerating such prompt sentences based on updated user conditions. This limits the ability of the server to adaptively control the generative model and results in redundant computations and fragmented logic across the application stack.

Third, most existing designs do not integrate emotion analysis and media association as first-class, programmable dimensions of the summarization process. Emotion recognition, if present at all, is often implemented as a separate service that may suggest content categories at the UI level but does not directly influence the generation of model input. Media content (images and video) is usually attached by simple keyword matching after text generation, without coordinated control through a common prompt or context object. Consequently, the server cannot consistently optimize processor usage and network resources in a way that jointly accounts for user state, summarization style, and media selection.

Fourth, translation is frequently implemented as an independent post-processing step with little or no integration into the main control flow of the summarization pipeline. The server typically sends completed summaries to a translation service without using prompt design or session-level metadata to guide which components should be translated, when to regenerate in a different language, and how translation interacts with user understanding level or emotional context. This disjoint handling leads to duplicated processing (for example, summarizing in one language and then translating versus summarizing directly in the target language) and complicates the logic of caching, logging, and model configuration on the server.

These technical issues, taken together, result in systems that are rigid, inefficient, and difficult to scale. The processor on the server side must execute multiple loosely coupled modules, often re-parsing and re-normalizing the same data under different conditions. The absence of a structured, prompt-centric control layer prevents the processor from efficiently orchestrating generative model calls, translation operations, emotion-aware adjustments, and media selection in a unified manner. There is therefore a need for an improved information processing architecture in which the processor systematically generates, manages, and regenerates prompt sentences as machine-interpretable control instructions, and uses them to coordinate summarization, formatting, translation, emotion-based adaptation, and media attachment. Such an architecture should reduce redundant processing, improve latency and resource utilization, and enable more precise and consistent control of generative AI models in response to changing user conditions.

The specific processing by the specific processing unit 290 of the data processing device 12 in Application Example 2 is realized by the following means.

The present invention provides a server comprising a processor configured to (i) acquire information from a source, convert the acquired information into character string data, and perform preprocessing including structuring and removal of unnecessary elements on the character string data, (ii) generate, based on the preprocessed character string data and user condition information, a prompt sentence that serves as a control instruction for a generative AI model to perform summarization, the prompt sentence explicitly specifying at least an output format, a level of detail, an expression style, and an information classification, (iii) input the prompt sentence into the generative AI model and obtain summary data in which main points of the character string data are extracted in accordance with the prompt sentence, (iv) reformat the summary data into a structured representation including bullet-point elements and convert the structured representation into a machine-readable data format, (v) select visual or moving-image data corresponding to the summary data by using an external information acquisition function and associate the selected data with the summary data within the structured representation, (vi) transmit the structured representation including the summary data and associated media data to a user terminal over a communication path, (vii) receive interactive operation data from the user terminal including updated condition information such as understanding level, interest field, emotional state, and output language type, regenerate the prompt sentence based on the updated condition information by selecting and applying a template corresponding to the updated condition information, and re-execute the generative AI model using the regenerated prompt sentence to update the summary data while reusing the preprocessed character string data, (viii) apply a translation function to at least part of the summary data to generate character string data in a different language when the updated condition information indicates a different output language type, and (ix) acquire emotion-state data from an emotion analysis function and control, in the prompt sentence, a classification of target information to be acquired and an expression style of the summary data in accordance with the emotion-state data. This enables the server-side processor to orchestrate summarization, formatting, media association, translation, and emotion-aware adaptation through a unified, prompt-centric control layer, thereby reducing redundant parsing and regeneration, improving computational efficiency and latency, and providing dynamically adjustable summaries that are consistently tailored to user conditions within a single, integrated information processing workflow.

The term “information source” refers to any origin of digital content or data, including but not limited to network-accessible services, data repositories, files, or streams from which text or media information can be acquired.

The term “character string information” refers to information represented as a sequence of characters in a machine-processable text format, including letters, numerals, symbols, and control characters.

The term “preprocessing” refers to a series of operations applied to acquired data prior to main analysis, including structuring, normalization, and removal of unnecessary elements, in order to transform the data into a format suitable for further processing.

The term “structuring processing” refers to operations that organize unstructured or semi-structured data into a defined logical or syntactic format, such as dividing text into sections, sentences, or tokens, and associating metadata with these elements.

The term “unnecessary-element removal processing” refers to operations that detect and delete portions of data that are not required for subsequent processing, such as markup tags, boilerplate, advertisements, navigation text, or other low-relevance content.

The term “user requirement conditions” refers to information indicating constraints or preferences specified by a user, including at least one of understanding level, interest field, output language type, desired tone, detail level, or target information category.

The term “prompt sentence” refers to a text instruction constructed for input to a generative AI model, the text instruction specifying at least a task, an output format, and one or more conditions that control how the generative AI model processes input data.

The term “generative AI model” refers to a machine-implemented model that generates output data such as text based on input data and learned parameters, including models that use probabilistic or neural-network-based natural language processing.

The term “summarization processing” refers to a process in which a model or algorithm analyzes input text and produces a shorter representation that preserves main points or essential information from the input.

The term “summary information” refers to data representing a condensed version of original information, including extracted main points, key facts, or high-level descriptions derived from the original information.

The term “bullet-point format” refers to an output structure in which discrete items of information are presented as a list of separate entries, each entry being visually or logically distinguished, for example by markers, indentation, or list indices.

The term “structured data” refers to data organized according to a predefined schema or format, such as a tree, table, or key-value representation, enabling direct machine interpretation and processing.

The term “visual information” refers to non-textual information that can be perceived visually, including still images, graphics, icons, diagrams, or other picture-based content.

The term “moving image information” refers to time-varying visual information such as video data, animation data, or sequences of image frames that convey motion.

The term “external information acquisition function” refers to a component or mechanism that obtains additional data from outside the system, such as through application programming interfaces, network requests, or data retrieval services.

The term “communication path” refers to any logical or physical channel that enables data transfer between components, including wired or wireless network connections and associated communication protocols.

The term “user terminal” refers to any information processing device operated by a user, such as a client computer, portable device, or display terminal, that can send data to and receive data from a server.

The term “interactive operation information” refers to data representing user interactions with a user interface, including selections, parameter changes, text inputs, gestures, or commands that are generated during use of the system.

The term “expression” refers to wording, style, or tone of output text, including choices of vocabulary, formality level, and rhetorical character used to present information.

The term “detail level” refers to a degree of granularity of information contained in output data, indicating how much specific content, explanation, or elaboration is included.

The term “information classification” refers to a categorization or labeling of information into types, topics, genres, or other classes, such as sports, economics, technology, or entertainment.

The term “translation function” refers to a function, module, or service that transforms text from one natural language to another natural language while preserving semantic content as much as possible.

The term “user emotional state” refers to a condition representing a user's emotion at a given time, such as joy, sadness, excitement, relaxation, surprise, or similar affective states.

The term “emotion analysis function” refers to a component or service that estimates a user emotional state based on input data such as facial images, voice signals, physiological signals, or text.

The term “output format” refers to a specification of the structural and presentational characteristics of data generated by the system, including layout, list structures, language, and any other structural constraints.

The term “understanding level” refers to an indication of a user's presumed ability to comprehend information, such as levels associated with age, expertise, or educational background.

The term “interest field” refers to a subject area or topic category that a user prefers or is currently focused on, such as technology, sports, finance, or science.

The term “output language type” refers to a particular human language designated for generated text output, such as a specific natural language identified by a code or name.

The term “template information” refers to predefined data structures or text patterns that are used as bases for constructing prompt sentences or output formats, and that can be selected and combined according to condition information.

The term “condition information” refers to a set of parameters that influence system behavior, including one or more of understanding level, interest field, emotional state, output language type, and any additional user-specific or context-specific constraints.

The term “expression style” refers to a combination of linguistic and presentation attributes of text, including tone, politeness level, narrative style, and degree of technicality.

The term “server” refers to an information processing apparatus or computing environment that executes the processor-implemented functions described in the system, including acquisition, preprocessing, prompt generation, model invocation, formatting, media association, translation, and emotion-based adaptation.

The term “processor” refers to one or more hardware or virtual processing units that execute instructions to perform logical, arithmetic, control, and input/output operations, including central processing units, graphics processing units, or other programmable computation resources.

In one embodiment, a server, a terminal, and a user cooperate to implement the system. The server includes at least one processor, a main memory, a non-volatile storage device, a network interface, and optionally a hardware accelerator such as a graphics processing unit (GPU). The terminal includes a processor, a display, a pointing device or touch panel, a camera, a microphone, and a wireless or wired communication interface. The user operates the terminal to provide condition information and to consume summary information.

The server stores executable programs and configuration data in the non-volatile storage device. The server loads the executable programs into the main memory and executes them on the processor. The programs include modules such as a data acquisition module, a text preprocessing module, a prompt generation module, a generative AI invocation module, a summary formatting module, a media association module, a translation module, an emotion analysis interface module, and a session management module. The server implements these modules, for example, in a high-level language running on an operating system, and may utilize software libraries such as a general natural language processing library (for example, a toolkit similar to NLTK), a deep learning framework (for example, a framework similar to TensorFlow or PyTorch), and HTTP client libraries.

The server uses the data acquisition module to obtain information from one or more information sources. The server connects to remote content providers through the network interface and performs HTTP or HTTPS communication to receive article data, metadata, and associated media references. The server parses responses using a document parsing routine based on a general-purpose HTML or XML parser. The server thereby converts heterogeneous web data into internal character string information and metadata structures.

The server uses the text preprocessing module to convert the raw acquired information into normalized character string information. The server performs operations such as HTML tag removal, script and style section filtering, whitespace normalization, Unicode normalization, sentence segmentation, and tokenization. The server maintains an internal data structure in memory in which each article is represented by a record comprising at least fields for article identifier, title, normalized body text, language metadata, timestamp, and category labels. The server uses NLP libraries to perform sentence boundary detection and word tokenization so that subsequent summarization is applied to clean, structurally consistent input. This preprocessing reduces input noise and improves the stability and efficiency of the later neural-network-based summarization.

The server uses the prompt generation module to construct a prompt sentence that explicitly encodes summarization behavior. The server reads user requirement conditions and session context, including understanding level, interest field, output language type, desired tone, and user emotional state, which are stored in association with a session identifier. The server combines these conditions with the normalized article text to form a prompt sentence. For example, the server can generate prompt sentences such as:
“Please summarize the following news article as bullet points: {article body}”
“Summarize the following article in Japanese so that a middle school student can understand it. Output bullet points only: {article body}”
“Considering that the user feels sad, please create a calm and reassuring bullet-point summary of the following article: {article body}”
“Summarize the following sports article in a fresh and exciting tone suitable for a user who is excited: {article body}”

The server treats the prompt sentence as a structured control instruction rather than a mere user message. The server uses template information stored as text patterns with variable placeholders. The server selects a template based on the condition information and interpolates the article text and condition values into the template. This template-based construction provides a deterministic transformation from internal condition parameters to a specific input string for the generative AI model, which allows reproducible control and optimization of model behavior.

The server uses the generative AI invocation module to input the prompt sentence into a generative AI model. The server may host the generative AI model locally or access it through a remote inference service. In one embodiment, the generative AI model is an auto-regressive language model with a transformer architecture, comprising multiple self-attention layers, feedforward layers, and layer normalization components. The server uses a model that has been trained with supervised learning and optionally fine-tuned on summarization data. The server, during fine-tuning, uses a loss function such as cross-entropy over output token sequences and updates model parameters via gradient descent and backpropagation. The server can apply data augmentation techniques such as random sentence dropout or synonym substitution during training in order to improve model robustness to noisy or varied input.

The server, when invoking the generative AI model, specifies parameters such as maximum output length, temperature, top-k or top-p sampling configuration, and stop sequences. The server thereby constrains the generative process to produce concise, bullet-point-friendly content. The server inputs the prompt sentence as a sequence of token identifiers to the model, and the transformer network computes contextual representations using multi-head self-attention and position encodings. The server then obtains predicted output token distributions from the model and uses a deterministic or stochastic decoding algorithm to generate a final text sequence representing the summary information. This processing exploits the high-dimensional representations and parallel attention mechanisms inside the network to identify salient parts of the article more efficiently than rule-based summarization.

The server uses the summary formatting module to convert the generated summary information into a structured data representation. The server analyzes line breaks and punctuation in the generated text and splits the text into discrete bullet items. The server constructs a list data structure, such as an array of strings, each element containing one bullet item. The server additionally stores metadata, such as the language code, the applied template identifier, and the associated article identifier, in a dictionary structure. The server may compute a summary score or coverage metric by comparing token sets between the original article and each bullet item, and may discard items that fall below a threshold. This structured representation supports efficient downstream processing such as translation, emotion-based reformulation, and media association.

The server uses the media association module to select visual information or moving image information that corresponds to the summary information. The server derives keywords or concept vectors from the summary information by using feature extraction routines implemented with an embedding model or a keyword extraction algorithm. The server sends these keywords through an external information acquisition function that communicates with a media search service. The server receives candidate media items, each with metadata such as resolution, content rating, and license information. The server selects at least one media item per summary according to rules that optimize for resolution and topic relevance and registers the selected media item identifiers in the structured representation by linking them to the corresponding summary record.

The server uses the translation module when the condition information indicates that the output language type differs from the language of the generated summary information. The server passes each bullet item to a statistical or neural machine translation engine through a translation interface. The server receives translated bullet items and replaces or augments the original bullet items in the structured representation. Because the translation occurs at the structured bullet-level rather than at the article-level, the server reduces the amount of data transmitted to the translation engine and thereby reduces communication load and translation latency. Alternatively, the server may generate prompt sentences that request the generative AI model to output directly in the target language, in which case the server can bypass separate translation and further reduce overall processing steps.

The server uses the emotion analysis interface module to acquire user emotional state information. The server receives, from the terminal, data such as facial images and voice segments captured by the camera and microphone. The server forwards these signals to an emotion analysis function, which may be implemented as a convolutional-recurrent network that processes image frames and spectral features of the audio signal. The emotion analysis function outputs a probability distribution over emotion classes; the server selects an emotion label by picking the maximum probability class or an expected value. The server stores the label and a confidence score in the session context and uses these values when generating or regenerating prompt sentences.

The server, by incorporating the user emotional state into the prompt generation, applies non-conventional coordination of summarization parameters. For example, when the emotional state indicates sadness with high confidence, the server selects templates that enforce a calm and reassuring tone and adjusts the information classification to favor less stressful categories. When the emotional state indicates excitement, the server selects templates that enforce an energetic tone and prioritizes categories such as sports or entertainment. This rule set forms a deterministic mapping from emotion labels to both content selection parameters and linguistic style instructions in the prompt sentences. Because this mapping is executed in the server's processor at the prompt generation level, the system avoids ad-hoc client-side filtering and re-summarization, thereby improving consistency and computational efficiency.

The terminal presents a user interface that allows the user to specify requirement conditions, to provide feedback, and to view generated summaries. The terminal uses a user interface framework, such as a cross-platform mobile framework, to implement scrolling lists, buttons, sliders, and text input fields. The terminal uses its network interface to send condition information, including understanding level, interest field, language preference, and textual instructions, to the server over HTTP. The terminal also sends emotion-related data to the server when the user has granted permission to use sensors. The terminal receives structured summary representations from the server and renders bullet lists and associated media items on the display. The terminal arranges the bullet lists in a vertically scrollable layout so that the user can continuously browse summaries. The terminal may adjust font size and layout based on understanding level and device characteristics.

The user interacts with the terminal to request summarization for specific content or categories. The user can input text such as “Please summarize the following news article as bullet points: {article body}” into an input field. The user can select options such as “middle school level”, “professional level”, “technology”, or “sports” from on-screen controls. The user can request translations, for example, by selecting an output language or typing a request such as “Summarize this article in Japanese so that a middle school student can understand it.” The user thus provides high-level, human-interpretable instructions, while the server transforms these instructions into low-level, machine-interpretable prompt sentences and structured parameters that control the generative AI model.

The server, in addition to one-time summarization, supports interactive adjustment of output by regenerating prompt sentences and reusing preprocessed article data. When the user changes conditions on the terminal, the terminal sends updated condition information to the server without resending the original article text. The server accesses the stored normalized article text from memory and constructs a new prompt sentence using a different template or tone instruction. Because the server does not repeat network acquisition and preprocessing, the amount of processing and communication is reduced. This architectural choice leads to lower latency and reduced CPU and memory usage, particularly under high load.

The server uses a session management module to maintain per-user and per-request context, including identifiers for the article, the chosen template, emotion labels, and any previous summaries. The server stores this context in a key-value data store or in an in-memory cache. The server uses this context to avoid redundant model invocations; for example, when the user requests a small refinement in tone or detail level, the server can condition the new prompt sentence on previously generated summary information instead of the full article text, thereby shortening the model input sequence. This technique reduces computation performed by the transformer network, which scales approximately quadratically with input length in attention layers. By shortening inputs, the server decreases execution time and energy consumption on the processor or GPU.

The server can adopt alternative implementations of the generative AI model, such as encoder-decoder architectures, sequence-to-sequence models with attention, or hybrid systems that combine extractive and abstractive summarization components. The server can train the model offline with tasks that mirror the described prompt sentences, so that the model learns to respond appropriately to explicit instructions regarding bullet-point format, tone, and audience level. During training, the server can use a training dataset with paired articles and multi-style summaries, minimizing a combined loss that accounts for content coverage and stylistic similarity. By tailoring the training objective to prompt-controlled summarization, the model becomes more responsive to the specific instructions generated by the prompt generation module.

The server may also implement a rule-based post-processing layer that enforces constraints which are difficult to encode directly in the model. For example, the server can enforce a maximum number of bullets, a prohibition of certain terms, or a minimum coverage of named entities. The server evaluates each generated bullet item against these rules, and when a violation is detected, the server either removes the item or triggers regeneration with an adjusted prompt sentence that explains the constraint. This hybrid architecture—generative neural network plus deterministic constraint checking—achieves improved accuracy and reliability compared with systems that rely solely on generic model outputs.

The described system provides technical improvements over conventional content delivery and summarization mechanisms. The server uses a unified, prompt-centric architecture that encodes multiple dimensions of control (language, detail, tone, category, and emotion) into a single input sequence for the generative AI model. Because the server generates prompt sentences automatically from structured parameters and reuses preprocessed texts and session context, the server reduces the number and size of model calls and translation requests. This leads to lower CPU and GPU utilization, reduced memory traffic for token sequences, and decreased network bandwidth for external service communication. The server can therefore respond more rapidly to interactive user requests while maintaining consistent and predictable summarization behavior.

The server further improves data management by producing and maintaining structured summary objects that integrate text, media references, and metadata. These data structures allow the server and terminal to perform efficient incremental updates, caching, and selective retransmission. For example, when only the output language changes, the server can keep the bullet structure and media references unchanged and only adjust the textual fields. This selective processing reduces redundancy and improves both computational efficiency and communication efficiency, constituting a concrete improvement in computer operation rather than a mere automation of human reading and rewriting.

The system can be implemented in multiple variants. The server can reside in a cloud environment, on a local data center, or on-premises hardware. The generative AI model can be run on dedicated accelerators or on general-purpose processors. The terminal can be a smartphone, a tablet, a laptop, or a specialized display device. The emotion analysis function can be integrated into the server, into the terminal, or into a third-party service. The translation function can be integrated into the generative AI model through multilingual training, or can be provided by an independent translation module. These variations can be combined as needed to adapt to different deployment environments while preserving the essential features of prompt-centric, emotion-aware, multi-language summarization controlled by explicit condition parameters.

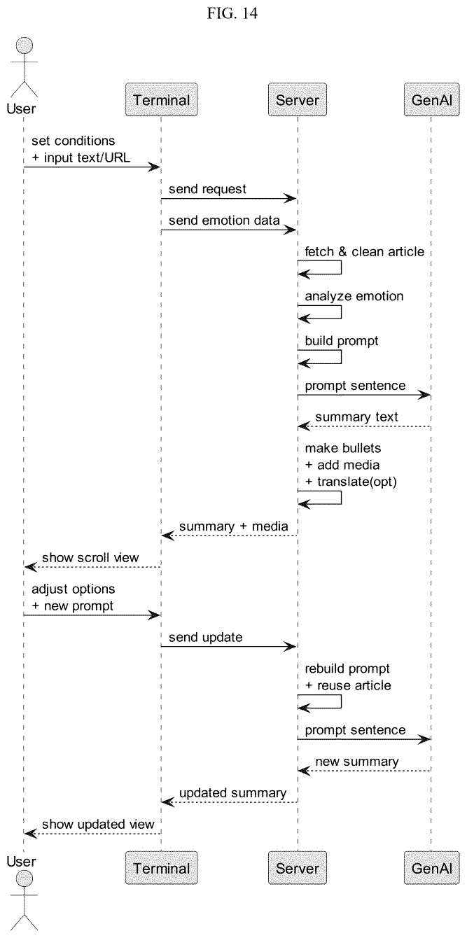

The following describes the processing flow using FIG. 14.

### Step 1:

User operates the terminal to specify summarization conditions.

User selects, on the terminal's user interface, at least one category (e.g., technology, sports), an understanding level (e.g., middle school, expert), an output language, and optionally a preferred tone. User may additionally input raw text or a URL and may type a free-form instruction such as a prompt sentence (e.g., “Please summarize the following news article as bullet points: {article body}”).

Input: user touch events, key inputs, and optional pasted text or URL.

Output: a structured condition object on the terminal, containing fields such as category, understanding level, output language type, tone preference, article source (text or URL), and raw prompt sentence text.

### Step 2:

Terminal converts user actions into a machine-readable request and transmits it to the server.

Terminal encodes the condition object as a structured message (e.g., JSON) that includes the article source, user requirement conditions, and session identifier. Terminal establishes an HTTP or HTTPS connection to the server and posts this message to a designated endpoint.

Input: structured condition object generated in Step 1.

Output: a network request message sent over a communication path to the server, containing serialized condition data and article source information.

### Step 3:

Terminal optionally captures emotion-related sensor data and sends it to the server.

Terminal activates the camera and microphone (with prior user permission), captures a short sequence of image frames and an audio segment, compresses them if necessary, and attaches them to the same or a separate request to the server.

Input: sensor signals from the camera and microphone.

Output: encoded image and audio data transmitted to the server as part of an emotion data payload.

### Step 4:

Server receives the request and emotion data and initializes session context.

Server accepts the HTTP request, parses the structured condition data, and stores session-specific information (user identifier, session identifier, conditions) in a session management structure in memory. Server associates any received emotion data payload with this session.

Input: network request containing condition data and optional emotion payload.

Output: in-memory session context that references user conditions, article source, and raw sensor data.

### Step 5:

Server acquires article text from information sources.

Server examines the article source field; if it is a URL or category, server uses a data acquisition module to perform HTTP requests or API calls to external content providers. Server retrieves HTML or JSON content and extracts title and body fields; if the article body has been directly provided as text, server simply records this text.

Input: article source specification from the session context.

Output: raw article content (HTML, JSON, or plain text) stored as character string information in the server's memory.

### Step 6:

Server preprocesses article text into normalized character string information.

Server passes the raw content to a text preprocessing module that removes HTML tags, script/style sections, and advertisements. Server normalizes whitespace and encodings (e.g., Unicode normalization), splits the text into sentences using a sentence boundary detector, and tokenizes words using an NLP library. Server removes boilerplate segments and low-information text using rule-based filters.

Input: raw article content from Step 5.

Output: normalized article body text and associated metadata (e.g., language, sentence boundaries) stored in an internal data structure.

### Step 7:

Server analyzes emotion data to estimate user emotional state.

Server feeds the received image and audio data into an emotion analysis function (e.g., a convolutional-recurrent network or an external emotion API). Server computes probabilities for emotion classes and selects an emotion label (e.g., joy, sadness, excitement, relaxation) and confidence value. Server writes this emotion label into the session context.

Input: image and audio payload from Step 3.

Output: discrete emotion label and confidence score associated with the session.

### Step 8:

Server selects summarization and content parameters based on user conditions and emotional state.

Server reads understanding level, interest field, language type, tone preference, and emotion label from the session context. Server consults a rule set or mapping table that associates combinations of emotion and category with content parameters (e.g., preferred article types, maximum bullet count, tone style). Server computes a parameter vector (e.g., {detail level, tone, language, max bullets, category filter}) to drive prompt construction and model invocation.

Input: condition data and emotion label from Steps 4 and 7.

Output: a summarization parameter vector stored in the session context.

### Step 9:

Server generates a prompt sentence for the generative AI model.

Server selects a prompt template that matches the parameter vector, such as a template for middle-school understanding level in a particular language and tone. Server interpolates the normalized article text and condition placeholders into the template to produce a concrete prompt sentence such as:
“Summarize the following article in Japanese so that a middle school student can understand it. Output bullet points only: {normalized article body}”
or
“Considering that the user feels sad, please create a calm and reassuring bullet-point summary of the following article: {normalized article body}”.

Input: normalized article body and parameter vector from Steps 6 and 8.

Output: a fully constructed prompt sentence string representing a control instruction for the generative AI model.

### Step 10:

Server invokes the generative AI model with the prompt sentence.

Server tokenizes the prompt sentence into token IDs according to the model's vocabulary, sets generation parameters (e.g., max tokens, temperature, top-p), and submits the token sequence to a transformer-based generative AI model. Inside the model, multi-head self-attention, feedforward layers, and normalization layers compute contextual embeddings, and a decoding algorithm generates output token sequences. Server converts output tokens back to text.

Input: prompt sentence string from Step 9.

Output: raw generated summary text produced by the generative AI model.

### Step 11:

Server formats the generated summary into bullet-point structured data.

Server parses the generated text, splits it at line breaks or bullet markers, and trims whitespace around each segment. Server removes empty or overly short segments, enforces an upper bound on the number of bullets, and stores each bullet as an element of a list. Server attaches metadata such as template identifier, emotion label, and language code to this list structure.

Input: raw generated summary text from Step 10.

Output: a structured summary object containing an ordered list of bullet items and associated metadata.

### Step 12:

Server associates visual or moving-image information with the summary object.

Server extracts keywords or semantic embeddings from the bullet items using a feature extraction routine. Server queries a media search service through an external information acquisition function with these keywords and receives candidate image or video metadata. Server ranks candidates by relevance and quality and selects one or more items, then adds their identifiers or URLs to the structured summary object.

Input: structured summary object from Step 11.

Output: enriched summary object linking bullet items with selected visual or moving-image references.

### Step 13:

Server optionally translates the bullet-point summary to another language.

Server compares the current language of the bullet items with the requested output language in the session context. If they differ and direct generation in that language was not requested, server sends each bullet item to a translation function, receives translated strings, and replaces or augments the bullet list with the translated versions. Server updates language metadata accordingly.

Input: enriched summary object from Step 12 and requested output language.

Output: updated summary object whose bullet items are in the requested language.

### Step 14:

Server transmits the structured summary and media data to the terminal.

Server serializes the summary object, including bullet list, media references, and metadata, into a structured response format. Server sends this response over the established communication path to the terminal.

Input: updated summary object from Step 13.

Output: network response message containing the structured summary and media data delivered to the terminal.

### Step 15:

Terminal receives the response and renders a vertically scrollable interface.

Terminal parses the response, constructs user interface components for each bullet list and associated media, and inserts them into a vertically scrollable container. Terminal formats text according to understanding level (e.g., larger fonts for simpler content) and overlays thumbnails or video previews next to relevant bullet items.

Input: structured summary and media data from Step 14.

Output: rendered user interface on the terminal display showing bullet-point summaries and media in vertical scroll layout.

### Step 16:

User reviews the summaries and issues interactive adjustments.

User scrolls through the displayed content, reads bullet-point summaries, and views associated images or videos. User may tap controls such as “simplify further”, “increase detail”, “change tone to more positive”, or “translate to another language”, or may input a new instruction such as “Explain this in even simpler terms” as a text prompt.

Input: displayed user interface from Step 15.

Output: new user actions and instructions, captured as updated condition data and optional new prompt sentence text on the terminal.

### Step 17:

Terminal sends updated conditions to the server for re-summarization.

Terminal aggregates the new user actions into an updated condition object (e.g., modified detail level, new tone, new language). Terminal sends this object to the server, referencing the original article or previous summary identifier so that the original source text need not be resent.

Input: updated condition data and identifiers from Step 16.

Output: incremental update request transmitted to the server for further processing.

### Step 18:

Server regenerates the prompt sentence and updates the summary using existing data.

Server retrieves the normalized article text and existing session context using the identifiers from the incremental request. Server recomputes the parameter vector according to the new conditions, selects a different template if necessary, and constructs a new prompt sentence (e.g., “Please give a shorter, simpler bullet-point summary of the following article: {normalized article body}”). Server re-invokes the generative AI model, re-formats the output into bullets, optionally reuses previously selected media, and sends the updated summary back to the terminal.

Input: incremental update request with new conditions and stored article data.

Output: revised structured summary object and response message returned to the terminal for display.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

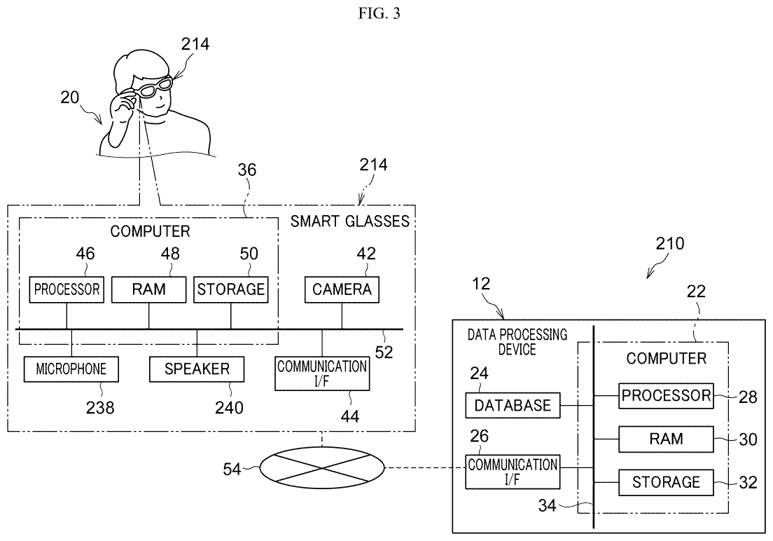

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

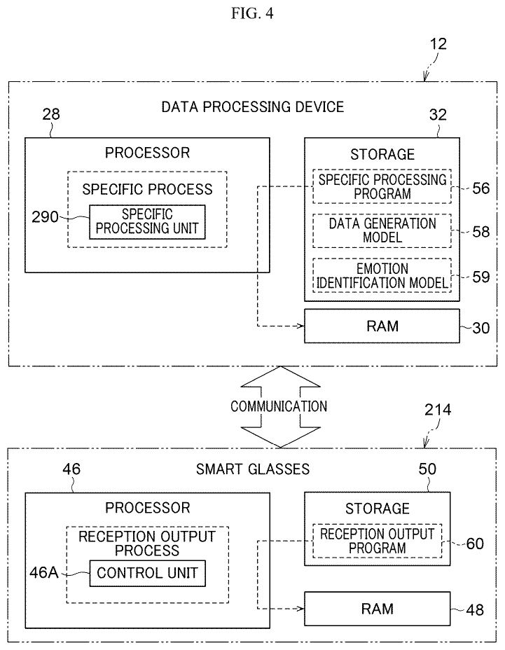

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

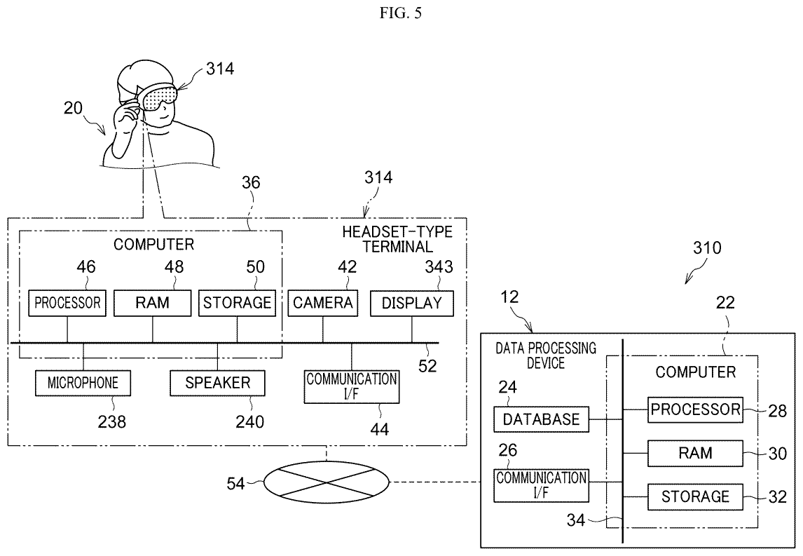

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

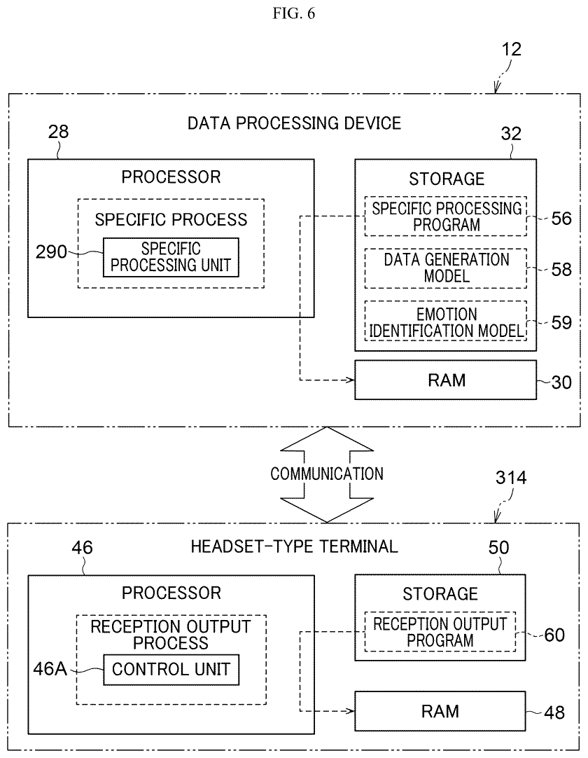

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56.

The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples.

Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

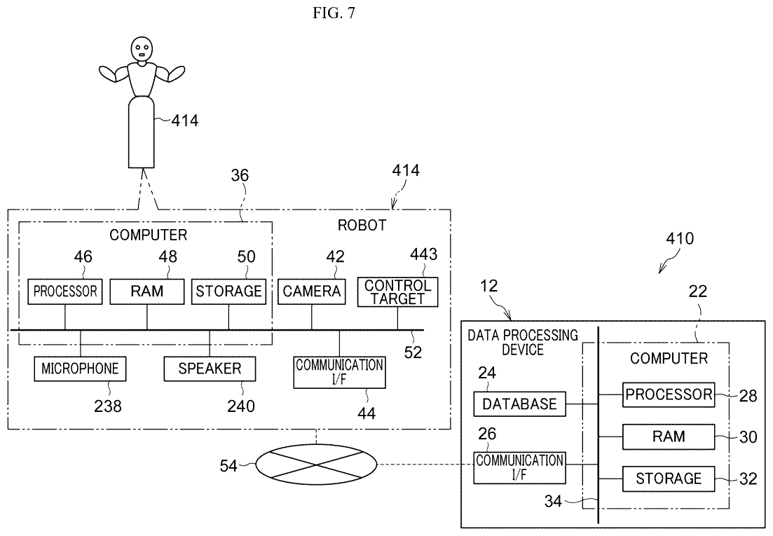

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

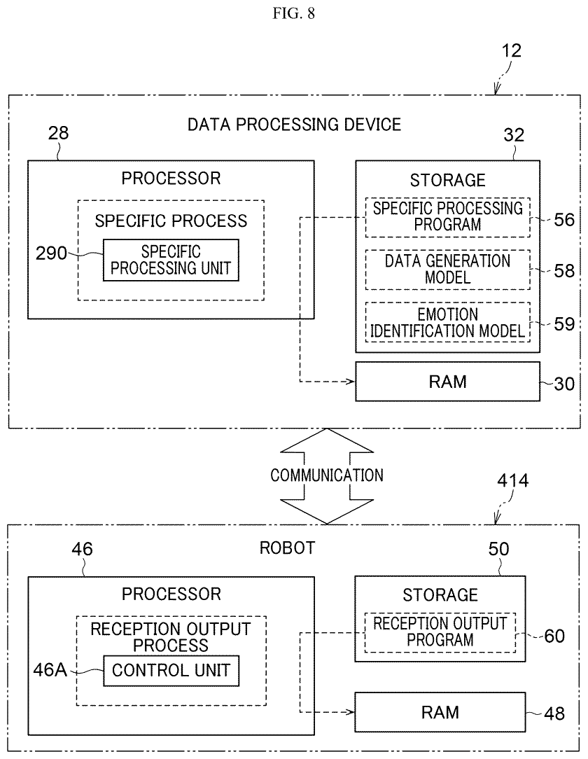

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56.

The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like.

The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

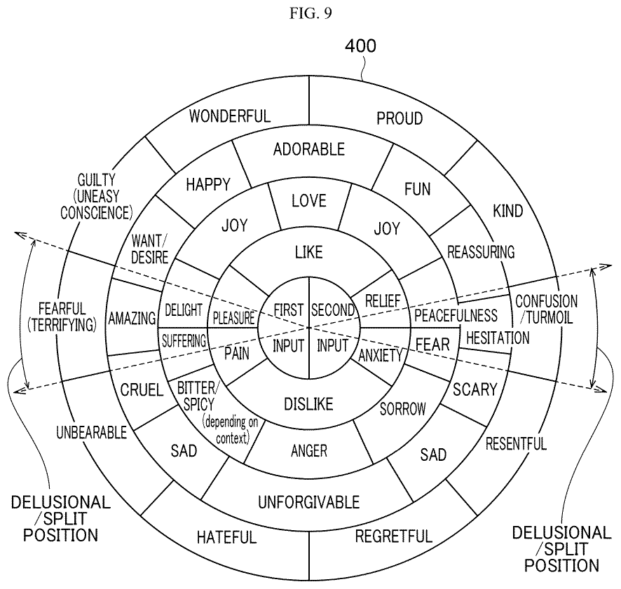

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

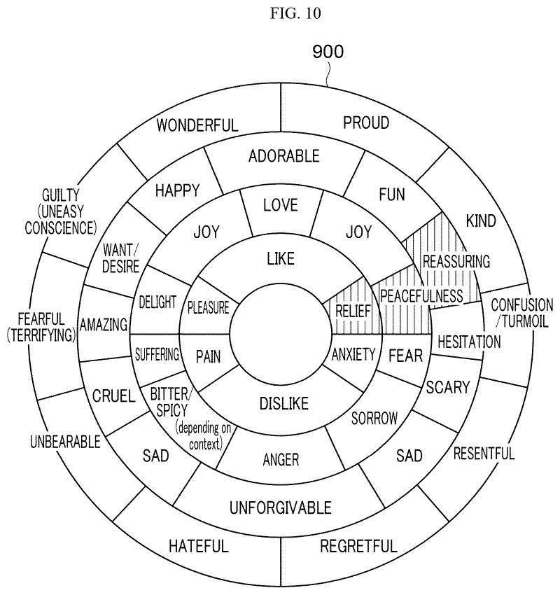

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief“, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire electronic information from an information providing device on a communication network,
extract body text from the acquired electronic information using at least one structured document analysis program or data structure analysis program in accordance with a format of the electronic information, delete unnecessary data, and perform character string normalization to generate analysis text data,
construct, on the basis of the analysis text data and summary conditions received from a user, a prompt sentence described in a natural language, the prompt sentence including instruction content regarding a summary target text, an output format, an output language, a comprehension level, and an amount of information, and generate input data including the prompt sentence and transmit the input data to a generative AI model,
analyze a summary result acquired from the generative AI model and generate summary text data in a predetermined display format by correcting line breaks and item symbols such that the summary text data is in a list format including at least one of a bullet list format and a numbered list format,
transmit response data including the summary text data to a user terminal in accordance with a communication protocol,
obtain, as a dialogue history, additional instructions or correction instructions that are input alternately from the user terminal, reconstruct a prompt sentence including the dialogue history and a previous summary result, and re-input the reconstructed prompt sentence to the generative AI model so as to progressively update summary content or expressions on the basis of a plurality of responses, and
convert the summary text data into a different language specified by the user by using at least one language determination program or translation program.

### (Supplementary 2)

The system according to supplementary 1,
wherein the processor is configured to
generate, as the prompt sentence to be transmitted to the generative AI model, a prompt sentence that instructs, in a natural language, extraction of main events and factors from the analysis text data acquired from the information providing device and summarization of the main events and factors as a list of items equal to or fewer than a predetermined number, and to concatenate the analysis text data to the prompt sentence and transmit the concatenated data to the generative AI model.

### (Supplementary 3)

The system according to supplementary 1,
wherein the processor is configured to
determine parameters indicating at least a target reader group, an allowable word count, presence or absence of use of technical terms, and a level of explanatory detail on the basis of input information received from the user terminal, select a template from among a plurality of template groups associated with the parameters, and generate the prompt sentence including a natural language instruction that specifies a comprehension level in accordance with the selected template, and input the prompt sentence to the generative AI model.

### Application Example 1

### (Supplementary 1)

A system comprising a processor,
wherein the processor is configured to
receive, from a user terminal, request information including at least an article category, a summarization style, a display language, and browsing status,
search, based on the request information, a comprehensive information source to retrieve a plurality of information items, extract and rank the information items using attribute information, and select at least one information item as a summarization target,
acquire text data and media data from the summarization target information item, and perform preprocessing on the text data including at least syntactic analysis, removal of unnecessary information, and language determination,
execute, based on a result of the language determination, machine translation to convert the text data or the preprocessed text data into a language corresponding to the display language of the user terminal,
generate, based on the article category and the summarization style included in the request information and based on the preprocessed text data or the translated text data, a prompt sentence for instructing a generative artificial intelligence model to perform key point extraction and to generate a summary in a bullet-point format,
input the prompt sentence and the text data into the generative artificial intelligence model, and obtain summary text output from the generative artificial intelligence model,
   analyze the summary text to divide and format the summary text into individual bullet-point elements, control a number of the bullet-point elements and unify expressions of the bullet-point elements, and associate the bullet-point elements with the media data to generate a summary display data structure,
transmit the summary display data structure to the user terminal as screen configuration information in a format that allows continuous viewing by vertical scrolling,
receive, from the user terminal, interactive update input regarding at least one of the article category, the summarization style, and a comprehension level, and dynamically modify the prompt sentence according to the update input to execute re-summarization processing, and
perform translation processing to mutually convert the summary text and the summary display data structure among a plurality of languages, and transmit a result of the translation processing to the user terminal.

### (Supplementary 2)

The system according to supplementary 1,
wherein the processor is configured to
use a prompt sentence that instructs the generative artificial intelligence model to analyze the text data included in the information item, extract at least main events, related entities, and impact content, and generate the extracted content as the summary text in the bullet-point format.

### (Supplementary 3)

The system according to supplementary 1,
wherein the processor is configured to
generate, based on preference information acquired from a user and including at least a comprehension level, a style type, and an interest field, a prompt sentence that instructs a summary expression corresponding to at least one of an expert-oriented explanation, a general explanation, and a beginner-oriented explanation, and to apply a summary template associated with the preference information to adjust the expression of the summary text generated by the generative artificial intelligence model.

### Example 2

### (Supplementary 1)

A system comprising a processor,
wherein the processor is configured to
acquire information from an information source, convert the acquired information into text data, and perform preprocessing on the text data, and
generate, on the basis of the preprocessed text data and a prompt sentence received from a user terminal, a prompt to instruct a generative artificial intelligence model to analyze and summarize the information, and input the prompt into the generative artificial intelligence model, and
format summary information output from the generative artificial intelligence model into a predetermined display format including a format that allows continuous vertical display, and transmit the formatted summary information to the user terminal, and
perform, on the basis of an additional prompt sentence or operation instruction input in a dialog form from the user terminal, iterative adjustment of the summary information by instructing the generative artificial intelligence model again to change at least one of length, level of detail, target domain, or expression level of the summary information, and
determine a language of the summary information and, when the language is different from a target language specified by a user, translate the summary information into the target language by using machine translation processing, and
generate new summary information corresponding to the dialog-type prompt sentence by reusing, on the basis of identification information received from the user terminal, at least one of original data acquired from the information source and existing summary information, and provide the new summary information to the user terminal, and
record processing history and performance information relating to the acquiring, preprocessing, summarizing, translating, and formatting, and update control parameters for subsequent prompt generation and summarization processing.

### (Supplementary 2)

The system according to supplementary 1,
wherein the processor is configured to
use a prompt that instructs the generative artificial intelligence model to analyze the information acquired from the information source and summarize key points of the information in at least one of a bullet-point format and a structured format with headings.

### (Supplementary 3)

The system according to supplementary 1,
wherein the processor is configured to
generate a prompt that instructs, on the basis of user input, switching of an expression of the summary information according to at least one of a plurality of comprehension levels, user attributes, and usage purposes, and apply a template corresponding to the switching to output of the generative artificial intelligence model.

### Application Example 2

### (Supplementary 1)

A system comprising a processor,
wherein the processor is configured to
acquire information from an information source, and
convert acquired information into character string information and perform preprocessing including structuring processing and unnecessary-element removal processing on the character string information, and
generate a prompt sentence, based on the preprocessed character string information and user requirement conditions, the prompt sentence being an instruction for a generative AI model to perform summarization processing, and
input the prompt sentence to the generative AI model and obtain summary information in which main points of the character string information are extracted, and
reformat the obtained summary information into a predetermined structure including a bullet-point format and convert the reformatted summary information into structured data, and
select visual information or moving image information corresponding to the summary information by using an external information acquisition function and associate the selected information with the summary information, and
transmit the summary information and the visual information or the moving image information to a user terminal via a communication path, and
regenerate, based on interactive operation information received from the user terminal, the prompt sentence so as to change expression, detail level, or information classification of the summary, and re-execute the generative AI model to update the summary information, and
convert the summary information into character string information in a different language by using a translation function, and
acquire data indicating a user emotional state from an emotion analysis function and control, in the prompt sentence, a classification of target information to be acquired and an expression style of the summary information in accordance with the user emotional state.

### (Supplementary 2)

The system according to supplementary 1,
wherein the processor is configured to
specify, in the prompt sentence, an output format such that the generative AI model analyzes the character string information acquired from the information source and outputs important matters in the bullet-point format.

### (Supplementary 3)

The system according to supplementary 1,
wherein the processor is configured to
dynamically generate the prompt sentence based on condition information including a user understanding-level, an interest field, an emotional state, and an output language type acquired from the user terminal, and select and apply template information corresponding to the condition information so as to interactively adjust the expression style and the information classification of the summary information.

What is claimed is:

1. A system comprising:
circuitry configured to:
acquire, via a communication interface coupled to a packet-switched network, electronic information from an external information providing apparatus, and convert the electronic information into analysis text data by executing a preprocessing pipeline comprising structured document parsing to extract content-bearing text regions and character string normalization;
determine a language classification of the analysis text data by computing language probability values using a statistical language identification model;
construct a prompt data structure comprising the analysis text data and summary condition parameters specifying at least an output item count, a comprehension level indicator, and an output format specification, and transmit the prompt data structure to a generative neural network model comprising a transformer-based architecture to acquire summary text data;
execute a post-processing operation on the summary text data, the post-processing operation comprising list element detection, item count enforcement, expression normalization, and format conversion, to produce formatted summary data conforming to the output format specification;
transmit the formatted summary data to a terminal device via the communication interface;
acquire refinement instruction data from the terminal device, retrieve dialogue history data associated with a session identifier from an information storage device, construct a refined prompt data structure comprising the refinement instruction data, the dialogue history data, and prior summary text data, and transmit the refined prompt data structure to the generative neural network model to acquire updated summary text data; and
when the language classification differs from a target language parameter, execute a translation operation on the summary text data using at least one of a neural sequence-to-sequence translation model or an additional prompt to the generative neural network model, to produce translated summary data in the target language.

2. The system according to claim 1, wherein the preprocessing pipeline further comprises determining a format of the electronic information from metadata, and when the format is a markup document, constructing a document tree, traversing nodes to locate content-bearing regions, and removing non-content nodes comprising script elements and style elements.

3. The system according to claim 2, wherein the preprocessing pipeline further comprises executing sentence segmentation on the extracted text regions using a tokenizer, applying named entity recognition to identify entity references, and computing term frequency values for extracted tokens.

4. The system according to claim 1, wherein the circuitry is further configured to estimate a token count of the prompt data structure using a token estimation module, and when the estimated token count exceeds a threshold for the generative neural network model, divide the analysis text data into a plurality of segments preserving sentence boundaries and generate a respective prompt data structure for each segment.

5. The system according to claim 4, wherein the circuitry is further configured to acquire a respective summary result for each segment from the generative neural network model, and merge the respective summary results into a consolidated summary by executing a deduplication operation and a coherence ranking operation on the merged summary items.

6. The system according to claim 1, wherein the summary condition parameters further comprise a target reader group indicator, a technical terminology permission flag, and an explanatory detail level, and the circuitry selects a prompt template from a plurality of stored prompt templates based on the summary condition parameters.

7. The system according to claim 6, wherein the circuitry is further configured to adjust the summary condition parameters based on a complexity metric computed from the analysis text data, the complexity metric comprising at least one of a sentence length distribution, a vocabulary diversity score, or a named entity density value.

8. The system according to claim 1, wherein the post-processing operation further comprises scanning each line of the summary text data for bullet markers or delimiters, splitting the summary text data into an ordered list of bullet-point elements, truncating the list to a maximum item count derived from the summary condition parameters, and normalizing capitalization and punctuation across the bullet-point elements.

9. The system according to claim 1, wherein the circuitry is further configured to associate the formatted summary data with media reference data by linking each summary item to corresponding image identifiers and video identifiers extracted from the electronic information using media identifier resolution.

10. The system according to claim 9, wherein the circuitry is further configured to generate a composite display data structure comprising the formatted summary data, resolved media resource locations, and layout attribute data, and transmit the composite display data structure to the terminal device.

11. The system according to claim 1, wherein the circuitry is further configured to acquire affective state data from the terminal device, input the affective state data into an emotion identification model to compute an emotion category and an emotion intensity score, and adjust at least one of the summary condition parameters or the prompt data structure based on the emotion category.

12. The system according to claim 11, wherein the affective state data comprises at least one of facial image data, voice spectrogram data, or biometric signal data, and the emotion identification model comprises a multimodal neural network that fuses features extracted from the at least one of the facial image data, the voice spectrogram data, or the biometric signal data.

13. The system according to claim 11, wherein the circuitry adjusts the summary condition parameters by modifying the comprehension level indicator to a simplified level when the emotion category indicates a negative affective state, and modifying the comprehension level indicator to a detailed level when the emotion category indicates a positive affective state.

14. The system according to claim 1, wherein the circuitry is further configured to record processing history data comprising prompt data structures, summary text data, token counts, processing durations, and user evaluation scores in the information storage device, and update control parameters for subsequent prompt generation based on the processing history data.

15. The system according to claim 14, wherein the circuitry is further configured to compute a summary quality metric from the processing history data by analyzing user evaluation scores and refinement iteration counts, and adjust a default prompt template selection based on the summary quality metric to reduce refinement iterations in subsequent sessions.

16. The system according to claim 1, wherein the circuitry is further configured to acquire a plurality of electronic information items from a plurality of external information providing apparatuses, rank the plurality of electronic information items based on attribute information comprising publication date, relevance score, and category match, and select a subset of the plurality of electronic information items as summarization targets.

17. The system according to claim 1, wherein the electronic information comprises news article data, the summary condition parameters specify a bullet-point format with a maximum of five items, the target reader group indicator specifies a general audience comprehension level, and the translation operation converts the summary text data from a detected source language into a user-specified display language.

18. A system comprising:
circuitry configured to:
acquire electronic information from an external information providing apparatus via a communication interface, and convert the electronic information into analysis text data by executing preprocessing comprising structured document parsing and character string normalization;
construct a prompt data structure comprising the analysis text data and summary condition parameters, and transmit the prompt data structure to a generative neural network model to acquire summary text data;
execute a post-processing operation on the summary text data comprising list element detection and expression normalization to produce formatted summary data;
transmit the formatted summary data to a terminal device;
acquire refinement instruction data from the terminal device, construct a refined prompt data structure comprising the refinement instruction data and dialogue history data, and transmit the refined prompt data structure to the generative neural network model to acquire updated summary text data; and
execute a translation operation on the summary text data to produce translated summary data in a target language.

19. The system according to claim 18, wherein the circuitry is further configured to acquire affective state data from the terminal device, compute an emotion category using an emotion identification model, and adjust the summary condition parameters based on the emotion category.

20. A method performed by circuitry via a communication interface coupled to a packet-switched network, the method comprising:
acquiring electronic information from an external information providing apparatus, and converting the electronic information into analysis text data by executing a preprocessing pipeline comprising structured document parsing to extract content-bearing text regions and character string normalization;
determining a language classification of the analysis text data by computing language probability values using a statistical language identification model;
constructing a prompt data structure comprising the analysis text data and summary condition parameters specifying at least an output item count, a comprehension level indicator, and an output format specification, and transmitting the prompt data structure to a generative neural network model comprising a transformer-based architecture to acquire summary text data;
executing a post-processing operation on the summary text data comprising list element detection, item count enforcement, expression normalization, and format conversion, to produce formatted summary data;
transmitting the formatted summary data to a terminal device;
acquiring refinement instruction data from the terminal device, retrieving dialogue history data, constructing a refined prompt data structure, and transmitting the refined prompt data structure to the generative neural network model to acquire updated summary text data; and
when the language classification differs from a target language parameter, executing a translation operation on the summary text data to produce translated summary data in the target language.
